(19) United States
(12) Patent Application Publication
(10) Pub. No.: US 2024/0393923 A1
(43) Pub. Date: Nov. 28, 2024

(54) METHOD FOR PLAYING VIDEO AND ELECTRONIC DEVICE

(71) Applicant: BEIJING DAJIA INTERNET INFORMATION TECHNOLOGY CO., LTD., Beijing (CN)

(72) Inventors: Zhen CHEN, Beijing (CN); Tianshu LI, Beijing (CN); Ximeng LU, Beijing (CN); Ge SONG, Beijing (CN)

(21) Appl. No.: 18/645,243

(22) Filed: Apr. 24, 2024

(30) Foreign Application Priority Data
May 22, 2023 (CN) 202310579397.3

(51) Int. Cl. G06F 3/0484; G06F 3/01; G06F 3/0481

(52) U.S. Cl. CPC G06F 3/0484; G06F 3/0481; G06F 3/016

(57) ABSTRACT

A method for playing a video, an electronic device and a non-transitory computer-readable storage medium are provided. The method includes: playing, in response to a fast multiplied-speed playing operation performed on a playing interface of the video when the video is being played, the video according to a first multiplied playing speed which is associated with the fast multiplied-speed playing operation; and playing, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.

This disclosure is based on and claims priority to Chinese Patent Application No. 202310579397.3, filed on May 22, 2023, the disclosure of which is herein incorporated by reference in its entirety.

### TECHNICAL FIELD

The present disclosure relates to the field of computer technologies, and in particular, relates to a method for playing a video and an electronic device.

### BACKGROUND

With the rapid development of Internet technologies and computer technologies, people have more diversified demands for related functions in a video playing process. For example, video playing platforms support playing at multiplied speeds, so as to meet personalized demands of users for different multiplied speeds of video playing in the video playing process.

In the related art, the video playing platforms usually achieve multiplied-speed playing in the following way: displaying a control configured to achieve multiplied-speed playing on an application interface of a video playing platform, and displaying, in response to a triggering operation performed on the control, various multiplied speeds of video playing for a user to select, such that a video is played according to a multiplied speed selected by the user.

### SUMMARY

The present disclosure provides a method for playing a video and an electronic device. Technical solutions of the present disclosure are as follows:

According to an aspect of the embodiments of the present disclosure, a method for playing a video is provided. The method includes: playing, in response to a fast multiplied-speed playing operation performed on a playing interface of the video when the video is being played, the video according to a first multiplied playing speed which is associated with the fast multiplied-speed playing operation; and playing, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.

According to another aspect of the embodiments of the present disclosure, an electronic device is provided. The electronic device includes: one or more processors; and a memory, configured to store program codes executable by the processor, wherein the processor is configured to execute the program codes to perform the following steps: playing, in response to a fast multiplied-speed playing operation performed on a playing interface of the video when the video is being played, the video according to a first multiplied playing speed which is associated with the fast multiplied-speed playing operation; and playing, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.

According to another aspect of the embodiments of the present disclosure, a non-transitory computer-readable storage medium having program codes therein is provided. The program codes, when executed by a processor of an electronic device, cause the electronic device to perform the following steps: playing, in response to a fast multiplied-speed playing operation performed on a playing interface of the video when the video is being played, the video according to a first multiplied playing speed which is associated with the fast multiplied-speed playing operation; and playing, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.

### BRIEF DESCRIPTION OF THE DRAWINGS

FIG. 1 is a schematic diagram of an implementation environment according to some embodiments of the present disclosure;

FIG. 2 is a flowchart of a method for playing a video according to some embodiments of the present disclosure;

FIG. 3 is a schematic diagram of a fast multiplied-speed playing operation according to some embodiments of the present disclosure;

FIG. 4 is a schematic diagram of a multiplied-speed adjustment operation according to some embodiments of the present disclosure;

FIG. 5A and FIG. 5B are schematic diagrams of a multiplied-speed adjustment track according to some embodiments of the present disclosure;

FIG. 6 is a flowchart of another method for playing a video according to some embodiments of the present disclosure;

FIG. 7 is a schematic diagram of a partial playing interface illustrating an implementation region of a multiplied-speed adjustment operation according to some embodiments of the present disclosure;

FIG. 8 is a schematic diagram of a method for playing a video, in which a multiplied-speed adjustment operation is an upward and downward sliding operation, according to some embodiments of the present disclosure;

FIG. 9 is a schematic diagram of another method for playing a video, in which multiplied-speed adjustment operation is an upward and downward sliding operation, according to some embodiments of the present disclosure;

FIG. 10 is a schematic diagram of a method for playing a video, in which a multiplied-speed adjustment operation is an operation performed on a multiplied-speed adjustment track, according to some embodiments of the present disclosure;

FIG. 11 is a schematic diagram of another method for playing a video, in which a multiplied-speed adjustment operation is an operation performed on a multiplied-speed adjustment track, according to some embodiments of the present disclosure;

FIG. 12 is a schematic diagram of still another method for playing a video, in which a multiplied-speed adjustment operation is an operation performed on a multiplied-speed adjustment track, according to some embodiments of the present disclosure;

FIG. 13 is a schematic diagram of yet another method for playing a video, in which a multiplied-speed adjustment operation is an operation performed on a multiplied-speed adjustment track, according to some embodiments of the present disclosure;

FIG. 14 is a flowchart of still another method for playing a video according to some embodiments of the present disclosure;

FIG. 15 is a schematic diagram of fourth prompt information according to some embodiments of the present disclosure;

FIG. 16 is a schematic diagram of a progress adjustment operation according to some embodiments of the present disclosure;

FIG. 17 is a schematic diagram of another progress adjustment operation according to some embodiments of the present disclosure;

FIG. 18 is a schematic diagram of sixth prompt information according to some embodiments of the present disclosure;

FIG. 19 is a block diagram of an apparatus for playing a video according to some embodiments of the present disclosure; and

FIG. 20 is a structural block diagram of a terminal according to some embodiments of the present disclosure.

### DETAILED DESCRIPTION

It should be noted that information (including but not limited to user device information and user personal information), data (including but not limited to data for analysis, stored data, displayed data, and the like), and signals involved in this application are authorized by a user or fully authorized by all parties, and the acquisition, use, and processing of the relevant data need to comply with relevant laws, regulations, and standards. For example, prompt information involved in some embodiments of the present disclosure is obtained under full authorization.

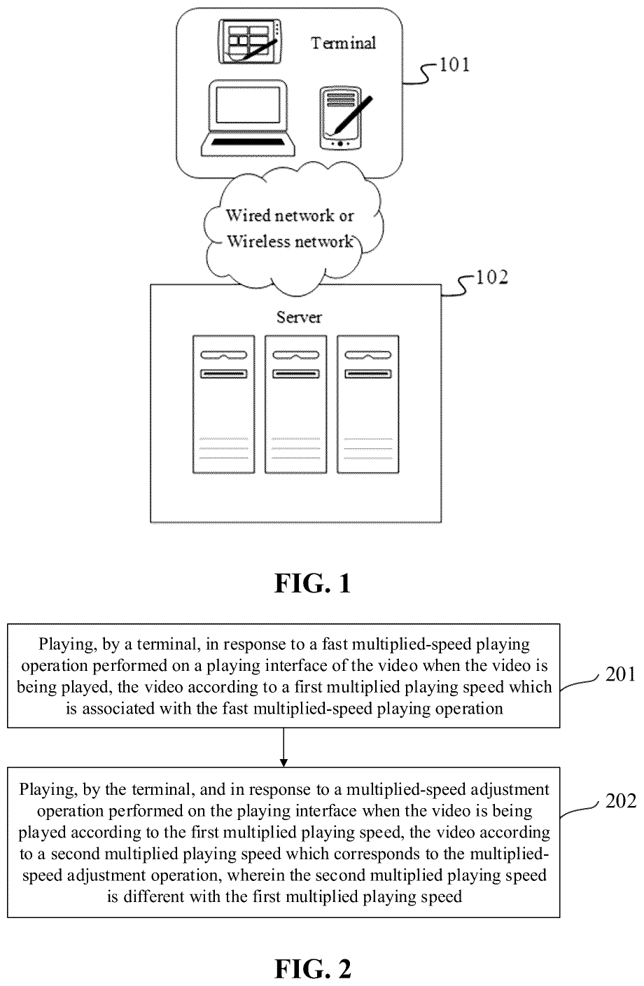

FIG. 1 is a schematic diagram of an implementation environment according to some embodiments of the present disclosure. Referring to FIG. 1, the implementation environment includes: a terminal 101 and a server 102. The terminal 101 and the server 102 are directly or indirectly connected by wired or wireless communication, but are not limited thereto.

The terminal 101 is at least one of an electronic device such as a smart phone, a smart watch, a desktop computer, a laptop computer, a virtual reality terminal, an augmented reality terminal, a wireless terminal, a laptop portable computer, and other devices. The terminal 101 generally refers to one of a plurality of terminals, and the embodiments of the present disclosure are illustrated only by using the terminal 101. Those skilled in the art will appreciate that a quantity of the terminals is more or fewer. Schematically, the terminal 101 is installed with and runs an application program to provide functions such as video playing, video browsing, and the like. For example, the application program may take the form of a web application program, a microprogram, a client, or the like, and the present disclosure does not make limitations on this. The microprogram refers to a program that is run by relying on other application programs, such as a mini program. Schematically, the terminal 101 is a terminal used by a target object. Use of a client as an application program run on the terminal 101 is taken as an example. An account of the target object is logged in on the client, and the target object browses a video list through the client to trigger the terminal 101 to play a selected video.

It should be noted that the server 102 may be an independent physical server, may be a server cluster or a distributed system formed by a plurality of physical servers, or may be a cloud server that provides cloud services, cloud databases, cloud computation, cloud functions, cloud storage, network services, cloud communication, middleware services, domain name services, security services, content delivery networks (CDNs), and basic cloud computation services such as big data and artificial intelligence platforms. A quantity of the server 102 may be more or fewer, and the embodiments of the present disclosure do not make any limitation on this. Schematically, the server 102 is configured to provide backend services for the application program run on the terminal 101. For example, the terminal 101 plays the corresponding video by acquiring the video from the server 102 in response to a video playing operation performed on a certain video. It should be understood that the quantity of the above server 102 may be more or fewer, and the embodiments of the present disclosure do not make any limitation on this. In some embodiments, the server 102 further includes other functional servers in order to provide more comprehensive and diverse services.

FIG. 2 is a flowchart of a method for playing a video according to some embodiments of the present disclosure. As shown in FIG. 2, the method is performed by a terminal. Schematically, the method includes following steps 201 and 202.

In step 201, the terminal plays, in response to a fast multiplied-speed playing operation performed on a playing interface of the video when the video is being played, the video according to a first multiplied playing speed which is associated with the fast multiplied-speed playing operation.

In some embodiments of the present disclosure, the terminal runs an application program that supports a video playing function, and an account of a target object is logged in on the application program. The target object is a user of application program or a user of the terminal. Schematically, the terminal displays an application interface of the application program, displays the playing interface of the video in response to a video browse operation performed by the target object on the application interface, and plays the video on the playing interface according to a default multiplied playing speed, wherein the default multiplied playing speed is 1× speed, that is, a normal playing speed. In some embodiments, the default multiplied playing speed is a preset multiplied playing speed. For example, the application program provides a setting function for the default multiplied playing speed, and the target object sets the default multiplied playing speed to be 1.2× speed through the function, such that the terminal plays the video according to the 1.2× speed. The embodiments of the present disclosure do not make any limitation on a specific numerical value of the default multiplied playing speed.

The fast multiplied-speed playing operation is an operation for fast starting multiplied-speed playing in the process of playing the video. The multiplied-speed playing means that the terminal plays the video at a multiplied playing speed different with the default multiplied playing speed, such that a personalized demand of the target object for different multiplied playing speeds is satisfied in the process of playing the video. Schematically, the fast multiplied-speed playing operation is associated with the first multiplied playing speed, and the first multiplied playing speed is different with the default multiplied playing speed. The terminal plays, in response to the fast multiplied-speed playing operation performed on the playing interface in the process of playing the video, the video according to the first multiplied playing speed. That is, the present disclosure provides a fast operation for starting the multiplied-speed playing. In the process that the terminal plays the video according to the default multiplied playing speed, the terminal fast starts the multiplied-speed playing on the basis of the fast multiplied-speed playing operation performed by the target object on the playing interface, so as to implement switching between multiplied playing speeds, thereby improving the operation efficiency of starting the multiplied-speed playing.

Schematically, the fast multiplied-speed playing operation includes at least one of the following.

(1) Long-press operation: For example, in response to receiving a pressing signal performed on the playing interface for n seconds (n>0) in the process of playing the video, the terminal determines an operation performed on the playing interface as the fast multiplied-speed playing operation, and plays the video according to the first multiplied playing speed.

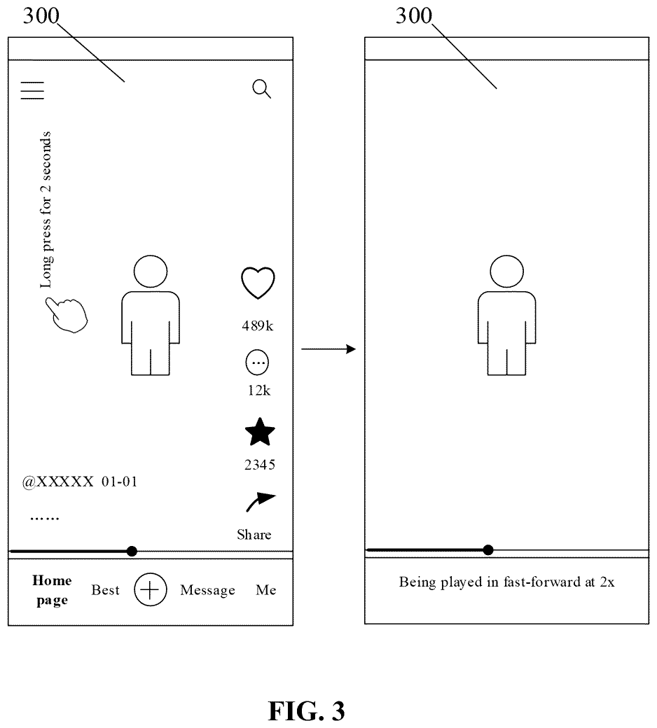

Schematically, referring to FIG. 3, FIG. 3 is a schematic diagram of a fast multiplied-speed playing operation according to some embodiments of the present disclosure. As shown in FIG. 3, a terminal plays a video according to a default multiplied playing speed on a playing interface 300, and plays, in response to the fast multiplied-speed playing operation (for example, long press for two seconds) performed on the playing interface 300, the video at a first multiplied playing speed, 2× speed, associated with the fast multiplied-speed playing operation. In the figure, “×” represents a multiplied playing speed. The long press operation may be performed on any region or a target region on the play interface. In the illustrated example, the target region is the sides or either left side portion or the right portion of the playing interface 300.

(2) Shaking operation: For example, in response to receiving a shaking signal with an eligible shaking amplitude in the process of playing the video, the terminal determines an operation performed on the playing interface as the fast multiplied-speed playing operation, and plays the video according to the first multiplied playing speed.

(3) Voice input operation: For example, in response to receiving a voice signal “Play at a multiplied speed” (which is set according to a need, and no limitation is made on this) in the process of playing the video, the terminal determines an operation performed on the playing interface as the fast multiplied-speed playing operation, and plays the video according to the first multiplied playing speed.

It should be understood that the above examples of the fast multiplied-speed playing operation are only illustrative and not intended to limit the present disclosure. In some embodiments, other operation manners are used to achieve the same function, such as a double-click operation, closing two fingers to slide towards a preset direction, and an upward sliding operation. The present disclosure is not limited thereto.

In step 202, the terminal plays, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.

In some embodiments of the present disclosure, the multiplied-speed adjustment operation is an operation for fast adjusting a multiplied playing speed in the process of playing the video, such that the personalized demand of the target object for timely adjusting the multiplied playing speed is satisfied in the multiplied-speed playing process of the video. Schematically, the target object performs the multiplied-speed adjustment operation on the playing interface to trigger the terminal to fast adjust the video being played from the first multiplied playing speed to the second multiplied playing speed which corresponds to the multiplied-speed adjustment operation, that is, the terminal starts the multiplied-speed playing through step 201 described above and plays the video according to the first multiplied playing speed. Then, the terminal can play, in response to the multiplied-speed adjustment operation performed by the target object on the playing interface, the video according to the second multiplied playing speed which corresponds to the multiplied-speed adjustment operation, such that the operation manner for adjusting the multiplied playing speed is simplified by the availability of fine adjustment on the multiplied playing speed, and the operation flexibility and the operation efficiency are improved.

Schematically, implementation of the multiplied-speed adjustment operation includes at least one of the following.

A first multiplied-speed adjustment operation: a sliding operation towards a preset direction.

Schematically, the multiplied-speed adjustment operation includes at least one of: sliding towards a first direction; and sliding towards a second direction. The first direction is opposite to the second direction, and the first direction and the second direction respectively correspond to different multiplied playing speeds. For example, the first direction is upward, corresponding to a 3× multiplied playing speed, and the second direction is downward, corresponding to a 1.5× multiplied playing speed. For another example, the first direction is rightward, corresponding to a 3× multiplied playing speed, and the second direction is leftward, corresponding to a 1.5× multiplied playing speed. The present disclosure is not limited thereto. The multiplied-speed adjustment operation is achieved by performing the sliding operation towards the preset direction. The operation manner for adjusting the multiplied playing speed is simplified, and the operation flexibility and the operation efficiency are improved. In other words, the present disclosure provides a simple operation manner to adjust the multiplied playing speed. For example, in a case that the current multiplied playing speed 2× is lower with respect to the target object, the multiplied playing speed is adjusted to 3× by simple upward sliding; and in a case that the current multiplied playing speed 2× is higher with respect to the target object, the multiplied playing speed is adjusted to 1.5× by simple downward sliding, which greatly simplifies the operation manner and achieves adjustment of the multiplied playing speed conveniently at any time according to a user need.

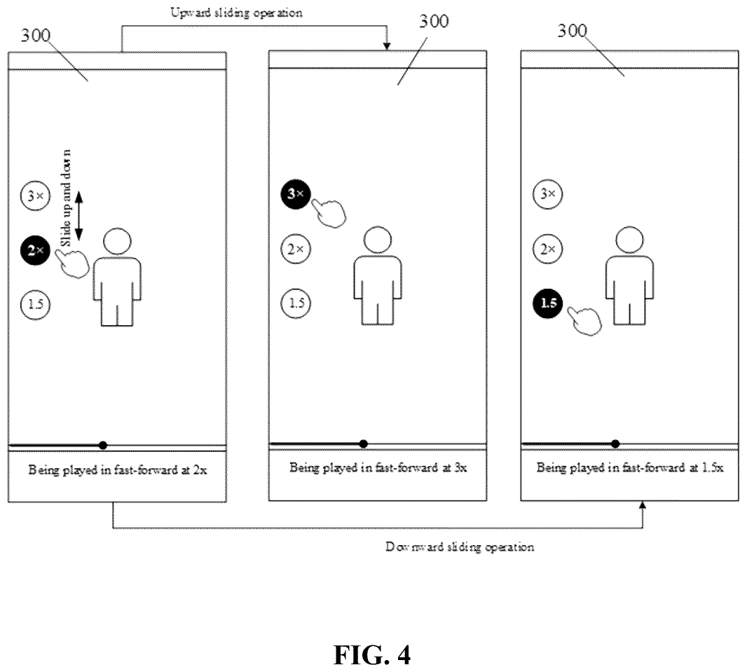

Schematically, referring to FIG. 4, FIG. 4 is a schematic diagram of a multiplied-speed adjustment operation according to some embodiments of the present disclosure. As shown in FIG. 4, by way of example, the multiplied-speed adjustment operation includes an upward sliding operation and a downward sliding operation (in the following embodiments, the two operations are collectively referred to as an upward and downward sliding operation, which will not be detailed). When the video is being played according to the first multiplied playing speed 2×, the terminal plays, in response to the upward sliding operation performed on the playing interface 300, the video according to the second multiplied playing speed 3× corresponding to the upward sliding operation, and plays, in response to the downward sliding operation performed on the playing interface 300, the video according to the second multiplied playing speed 1.5× corresponding to the downward sliding operation.

A second multiplied-speed adjustment operation: an operation performed on the multiplied-speed adjustment track. The multiplied-speed adjustment track indicates a plurality of multiplied playing speeds.

In some embodiments, the multiplied-speed adjustment track includes a plurality of multiplied-speed levels, and the different multiplied-speed levels respectively correspond to different multiplied playing speeds. Schematically, the multiplied-speed adjustment operation includes at least one of: a triggering operation performed on the multiplied-speed levels; and sliding on the multiplied-speed adjustment track to reach one of the multiplied-speed levels. For example, the plurality of multiplied-speed levels include 3×, 2×, 1.5×, 1×, and 0.5×, and “×” represents a multiplied playing speed. That is, the multiplied-speed adjustment track indicates a plurality of fixed multiplied playing speeds. The target object performs a triggering operation on a certain multiplied-speed level, or performs a sliding operation on the multiplied-speed adjustment track to select a fixed multiplied playing speed, and triggers the terminal to play the video according to the corresponding multiplied playing speed. By the method, it is convenient for the target object to intuitively know a selected multiplied playing speed, thereby improving the human-computer interaction efficiency.

In some embodiments, two ends of the multiplied-speed adjustment track respectively indicate an upper limit and a lower limit of adjustment of a multiplied playing speed. Schematically, the multiplied-speed adjustment operation includes at least one of: a triggering operation performed on any position on the multiplied-speed adjustment track; and sliding on the multiplied-speed adjustment track to reach any position. For example, the two ends of the multiplied-speed adjustment track respectively display prompt words of “fast” for the upper limit and “slow” for the lower limit. That is, the multiplied playing speed indicated by the multiplied-speed adjustment track is not fixed. A maximum value and a minimum value of the multiplied playing speed are set according to an actual need. The target object selects any multiplied playing speed by performing a triggering operation on any position or performing a sliding operation on the multiplied-speed adjustment track, so as to trigger the terminal to play the video according to the corresponding multiplied playing speed. In this way, the personalized need of the target object for adjusting the multiplied playing speed is met, such that the user experience is improved.

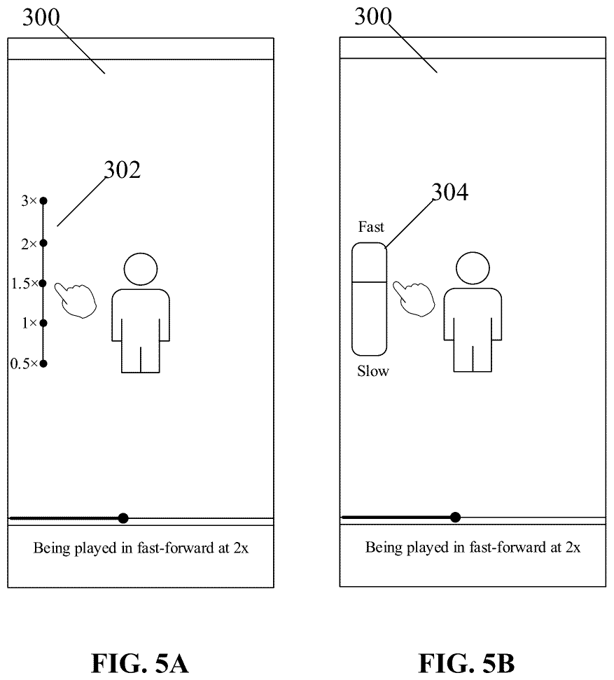

Schematically, referring to FIG. 5A and FIG. 5B, FIG. 5A and FIG. 5B are schematic diagrams of a multiplied-speed adjustment track according to some embodiments of the present disclosure. As shown in FIG. 5A, a multiplied-speed adjustment track 302 is displayed on a playing interface 300. The multiplied-speed adjustment track 302 includes a plurality of multiplied-speed levels, namely 3×, 2×, 1.5×, 1×, and 0.5×. The target object performs a triggering operation on a certain multiplied-speed level or performs a sliding operation on the multiplied-speed adjustment track to select a corresponding multiplied playing speed. FIG. 5B illustrates another embodiment of a multiplied-speed adjustment track 304. The multiplied-speed adjustment track 304 is an elongated bar and is displayed vertically on the playing interface 300. Two ends of the multiplied-speed adjustment track 304 respectively indicate an upper limit and a lower limit of adjustment of a multiplied playing speed. In the areas adjacent to the two ends, prompt words of “fast” and “slow” are displayed respectively. The target object can select any multiplied playing speed by performing a triggering operation on any position or performing a sliding operation on the multiplied-speed adjustment track.

It should be understood that the above examples of the multiplied-speed adjustment operation are only illustrative and not intended to limit the present disclosure. In some embodiments, other operation manners are used to achieve the same function, such as a triggering operation performed on a plurality of multiplied playing speed options. The present disclosure is not limited thereto.

In some embodiments, there is an overlapping region between an implementation region of the multiplied-speed adjustment operation and an implementation region of the fast multiplied-speed playing operation. For example, the implementation region of the fast multiplied-speed playing operation is on a left side of the playing interface, and the target object performs the fast multiplied-speed playing operation (for example, a long-press operation) on this region to trigger the terminal to start multiplied-speed playing, and the target object continues to perform a simple multiplied-speed adjustment operation on this region to trigger the terminal to adjust the multiplied playing speed. A sliding operation towards a preset direction is used as the multiplied-speed adjustment operation, which is taken as an example. After the fast multiplied-speed playing operation (for example, the long-press operation) is performed on a certain region of the playing interface, a user does not need to spend time and energy in performing the multiplied-speed adjustment operation on other regions of the playing interface, but continues to perform the simple sliding operation on the same region to adjust the multiplied playing speed. An operation performed on the multiplied-speed adjustment track is used as the multiplied-speed adjustment operation, which is taken as an example. After performing the fast multiplied-speed playing operation (for example, the long-press operation) on a certain region of the playing interface, a user does not need to spend time and energy in performing the multiplied-speed adjustment operation on other regions of the playing interface, instead the user can perform a simple click operation or sliding operation on the same region of the multiplied-speed adjustment track to adjust the multiplied playing speed. Therefore, the multiplied-speed adjustment operation provided in the present disclosure greatly improves the operation efficiency. Furthermore, the starting of the multiplied-speed playing and the adjustment of the multiplied playing speed are achieved by performing the operations on the same region, such that coverage of video contents on the playing interface is reduced, and the user experience is greatly improved. On the other hand, in the related technology, a playing interface is divided into a plurality of implementation regions. Different implementation regions correspond to different multiplied playing speeds. After performing an operation on a region to start multiplied-speed playing, a user needs to perform an operation on other regions to achieve the purpose of adjusting the multiplied playing speed. This method of prior art not only requires the user to remember the multiplied playing speeds corresponding to different implementation regions, but also requires the user to spend time and energy in searching for the corresponding implementation regions, resulting in low operation efficiency. Moreover, dividing the playing interface into the plurality of implementation regions causes covering on the video being played, which seriously affects the user experience.

In summary, in the method for playing the video provided in the embodiments of the present disclosure, a fast multiplied-speed playing operation associated with a first multiplied playing speed is provided, such that when the video is being played, multiplied-speed playing is quickly started in response to the fast multiplied-speed playing operation on a region of playing interface to play the video according to the first multiplied playing speed. Further, the method further provides a multiplied-speed adjustment operation on a region of the playing interface, such that in response to the multiplied-speed adjustment operation when the video is being played according to the first multiplied playing speed, the video is played according to a second multiplied playing speed which corresponds to the multiplied-speed adjustment operation. In some embodiments, the fast multiplied-speed playing operation and the multiplied-speed adjustment operation are performed in the same region. Therefore, a multiplied playing speed is quickly adjusted. The above method simplifies the operation manners for starting the multiplied-speed playing and adjusting the multiplied playing speed in the process of playing the video, improves the operation flexibility and the operation efficiency, and effectively improves the user experience.

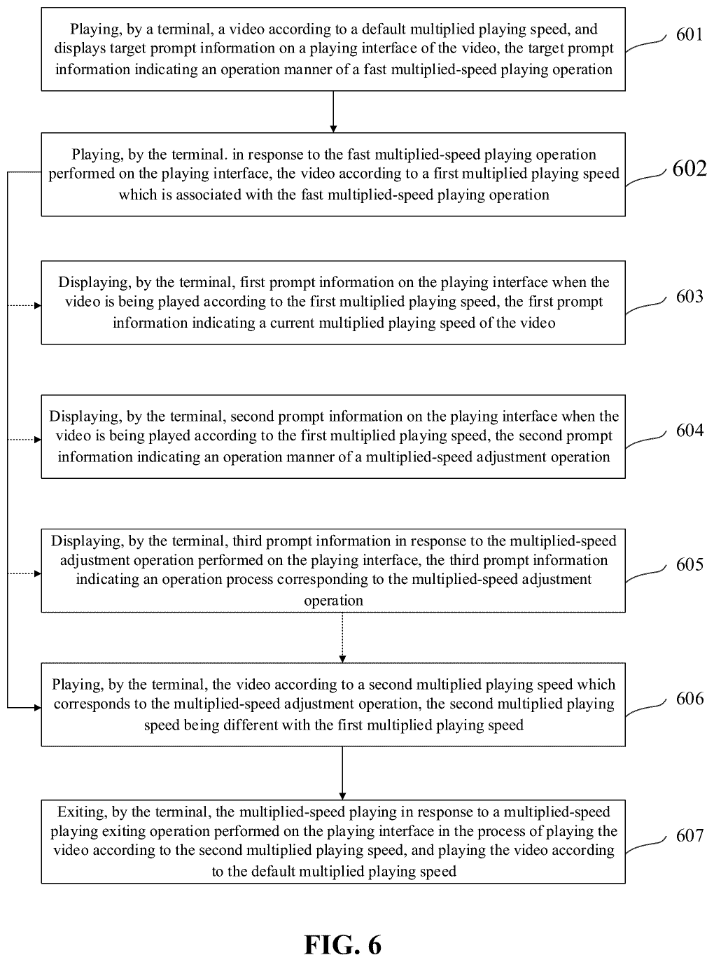

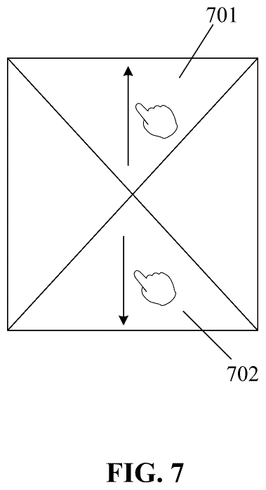

With reference to FIG. 2, a brief description is made to the method for playing the video provided by the present disclosure, and the embodiments of the present disclosure are described in detail with reference to FIG. 6.

FIG. 6 is a flowchart of another method for playing a video according to some embodiments of the present disclosure. As shown in FIG. 6, the method is applied to a terminal. Schematically, the method includes following steps 601 to 607.

In step 601, the terminal plays the video according to a default multiplied playing speed, and displays target prompt information on a playing interface of the video. The target prompt information indicates an operation manner of a fast multiplied-speed playing operation.

For the process of playing the video by the terminal according to the default multiplied playing speed and a specific form of the fast multiplied-speed playing operation, refer to step 201 described above, and repeated descriptions will be omitted here. In the process of playing the video, the terminal prompts the operation manner of the fast multiplied-speed playing operation by displaying the target prompt information on the playing interface, such that the human-computer interaction efficiency is effectively improved. In addition, a displaying position and a displaying form of the target prompt information on the playing interface are not limited in the present disclosure. For example, a long-press operation may be used as the fast multiplied-speed playing operation, and the terminal displays text target prompt information “Long press on the screen to play the video in fast-forward” on a top region of the playing interface. The present disclosure is not limited thereto.

In some embodiments, an implementation region of the fast multiplied-speed playing operation is a target region, and the target region is on at least one of two sides of the playing interface. Schematically, in the process of playing the video, the terminal highlights the target region so as to prompt the implementation region of the fast multiplied-speed playing operation, and the human-computer interaction efficiency is improved. Said highlighting refers to displaying the target area in a way which visually distinguishes from the other areas of the playing interface. For example, the terminal adds a layer or box with preset transparency (such as 50%) on the target area to highlight the target area, etc. In some embodiments, the terminal prompts the implementation region of the fast multiplied-speed playing operation by displaying the target prompt information. For example, the long-press operation used as the fast multiplied-speed playing operation is continued to be taken as an example. The terminal displays the target prompt information “Long press on regions on sides to play the video in fast-forward” on the displaying interface. It should be noted that the above description of the target region is only an example, and the present disclosure does not limit the specific position of the target region. For example, the target region may be a middle region of the playing interface, a region above a playing progress bar, and the like.

In some embodiments, the terminal displays the target prompt information on the playing interface in a case that a version of an application program is updated to provide the fast multiplied-speed playing operation, such that the target object knows a new function of the application program in time, and the human-computer interaction efficiency is improved. In some embodiments, the terminal displays the target prompt information in the process of playing the video at any time, and the present disclosure does not limit the timing of displaying the target prompt information by the terminal.

In step 602, the terminal plays, in response to the fast multiplied-speed playing operation performed on the playing interface, the video according to a first multiplied playing speed which is associated with the fast multiplied-speed playing operation.

For the specific implementation of this step, refer to step 201 described above, and repeated description will be omitted here.

In step 603, the terminal displays first prompt information on the playing interface when the video is being played according to the first multiplied playing speed. The first prompt information indicates a current multiplied playing speed of the video.

A displaying position and a displaying form of the first prompt information on the playing interface are not limited in the present disclosure. For example, the first multiplied playing speed is 2×, which is taken as an example. The terminal displays first prompt information as a text information “Being played in fast-forward at 2×” on a bottom region of the playing interface. The current multiplied playing speed of the video is prompted in time by displaying the first prompt information on the playing interface, such that the user experience is effectively improved. It should be noted that the first prompt information is a general term. In the embodiments of the present disclosure, prompt information defined to indicate a current multiplied playing speed of the video is referred to as the first prompt information, which is not described in detail later.

In step 604, the terminal displays second prompt information on the playing interface when the video is being played according to the first multiplied playing speed. The second prompt information indicates an operation manner of a multiplied-speed adjustment operation.

A displaying position and a displaying form of the second prompt information on the playing interface are not limited in the present disclosure. For example, an upward and downward sliding operation is used as the multiplied-speed adjustment operation, which is taken as an example. The terminal displays second prompt information as a text information “Slide up and down to switch the video playing speeds” on the top region of the playing interface. The operation manner of the multiplied-speed adjustment operation is prompted in time by displaying the second prompt information on the displaying interface, such that the human-machine interaction efficiency is improved. It should be noted that the second prompt information is a general term. In the embodiments of the present disclosure, prompt information defined to indicate an operation manner of the multiplied-speed adjustment operation is referred to as the second prompt information, which is not described in detail later.

In some embodiments, both the implementation region of the multiplied-speed adjustment operation and the implementation region of the fast multiplied-speed playing operation are target regions. Correspondingly, the terminal prompts the implementation region of the multiplied-speed adjustment operation by displaying the second prompt information. For example, the upward and downward sliding operation used as the multiplied-speed adjustment operation is continued to be taken as an example. The terminal displays the second prompt information “Slide up and down on regions on one of the two sides to switch the video playing speeds” on the top region of the playing interface. The side is the target region to implement the adjustment of the playing speed. The side is also the target region of implementing the fast multiplied-speed playing operation.

In some other embodiments, the implementation region of the multiplied-speed adjustment operation is determined according to a type of the multiplied-speed adjustment operation. For example, a sliding operation towards a preset direction is used as the multiplied-speed adjustment operation, which is taken as an example. The implementation region of the multiplied-speed adjustment operation is a preset region formed on the basis of the preset direction. Correspondingly, the second prompt information is, for example, “Slide up and down in the preset region to switch the video playing speeds”. Schematically, referring to FIG. 7, FIG. 7 is a schematic diagram of a partial playing interface illustrating an implementation region of a multiplied-speed adjustment operation according to some embodiments of the present disclosure. As shown in FIG. 7, an upward and downward sliding operation is used as the multiplied-speed adjustment operation, which is taken as an example. An implementation region of the operation is shown in the figure, that is, a preset region 701 formed on the basis of the first direction (e.g., an upward direction) and a preset region 702 formed on the basis of a second direction (e.g., a downward direction). It should be understood that, in a case that it is detected that the multiplied-speed adjustment operation is performed in a preset region, the terminal performs the subsequent corresponding flow. In a case that it is detected that the multiplied-speed adjustment operation is performed in a non-preset region, the terminal does not perform the subsequent corresponding flow.

It should be noted that in the present disclosure, execution orders of steps 603 and 604 described above are not limited, and the steps 603 and 604 may be executed synchronously, or step 604 is executed first before step 603.

In step 605, the terminal displays third prompt information in response to the multiplied-speed adjustment operation performed on the playing interface. The third prompt information indicates an operation process corresponding to the multiplied-speed adjustment operation.

A displaying position and a displaying form of the third prompt information on the playing interface are not limited in the present disclosure. For example, the upward and downward sliding operation is used as the multiplied-speed adjustment operation, which is taken as an example. The terminal displays the third prompt information formed by combining image and text on the playing interface, that is, displays an icon corresponding to the first multiplied playing speed 2×, an icon corresponding to a multiplied playing speed 3× corresponding to an upward sliding operation, and an icon corresponding to a multiplied playing speed 1.5× corresponding to a downward sliding operation performed on the playing interface. Because the terminal displays a corresponding sliding track and text on the playing interface in response to the upward sliding operation or the downward sliding operation performed on the playing interface, a current operation process is intuitively prompted by displaying the third prompt information on the playing interface. In this way, the user experience is effectively improved. It should be noted that the third prompt information is a general term. In the embodiments of the present disclosure, prompt information defined to indicate an operation process corresponding to the multiplied-speed adjustment operation is referred to as the third prompt information, which is not described in detail later.

In some embodiments, in the process of displaying the third prompt information, the terminal stops displaying the third prompt information in a case that no multiplied-speed adjustment operation is detected within a target duration, and the terminal displays the third prompt information until the multiplied-speed adjustment operation is detected again. That is, the terminal displays the corresponding operation process in the process of performing the multiplied-speed adjustment operation by the target object; the terminal does not display the operation process any more in a case that a duration that the target object does not perform the multiplied-speed adjustment operation reaches the target duration; and the terminal displays the third prompt information again in a case that the target object performs the multiplied-speed adjustment operation again. In this way, the excessive occupation of the playing interface by the prompt information and the covering on the video being played are avoided.

In step 606, the terminal plays the video according to a second multiplied playing speed which corresponds to the multiplied-speed adjustment operation. The second multiplied playing speed is different with the first multiplied playing speed.

For the specific implementation of this step, refer to step 202 described above, and repeated description will be omitted here.

In some embodiments, the terminal sends, in response to the multiplied-speed adjustment operation, a vibration prompt according to a vibration level corresponding to the second multiplied playing speed. Different multiplied playing speeds correspond to different vibration levels. For example, the plurality of multiplied playing speeds include 3×, 2×, 1.5×, 1× and 0.5×. Correspondingly, the vibration levels corresponding to these multiplied playing speeds are 5, 4, 3, 2, and 1 from high to low in sequence. A larger numerical value of a vibration level indicates a stronger vibration sense. In this way, the purpose of reminding a user is achieved efficiently, and the human-computer interaction efficiency and the user experience are improved.

It should be noted that in the present disclosure, execution orders of steps 605 and 606 described above are not limited, and the steps 605 and 606 may be executed synchronously, or step 606 is executed first before step 605.

In step 607, the terminal exits the multiplied-speed playing in response to a multiplied-speed playing exiting operation performed on the playing interface in the process of playing the video according to the second multiplied playing speed, and plays the video according to the default multiplied playing speed.

The present disclosure does not limit the specific implementation of the multiplied-speed playing exiting operation. For example, the multiplied-speed playing exiting operation is a click operation performed on any position on the playing interface. For another example, the multiplied-speed playing exiting operation is a triggering operation performed on a multiplied-speed playing exiting control on the playing interface. For still another example, in a case that the fast multiplied-speed playing operation is a long-press operation, in a process of responding to the multiplied-speed adjustment operation, the terminal makes a sustained response to the long-press operation to play the video at the current multiplied speed, and the multiplied-speed playing exiting operation is a release operation corresponding to the long-press operation.

In some embodiments, the terminal displays seventh prompt information on the playing interface in the process of playing the video according to the second multiplied playing speed. The seventh prompt information indicates an operation manner of the multiplied-speed playing exiting operation. A displaying position and a displaying form of the seventh prompt information on the playing interface are not limited in the present disclosure. For example, a long-press operation is used as the multiplied-speed playing exiting operation, which is taken as an example. The terminal displays seventh prompt information as text information “Release to exit the multiplied-speed playing” on the top region of the playing interface. It should be understood that the foregoing multiplied-speed playing exiting operation is described in the process of playing the video according to the second multiplied playing speed. The terminal displays the seventh prompt information when the video is being played according to the first multiplied playing speed in the same way. Correspondingly, the terminal exits the multiplied-speed playing in response to the multiplied-speed playing exiting operation when the video is being played according to the first multiplied playing speed, and plays the video according to the default multiplied playing speed. The present disclosure does not limit the displaying timing of the seventh prompt information. It should be noted that the seventh prompt information is a general term. In the embodiments of the present disclosure, prompt information defined to indicate an operation manner of the multiplied-speed playing exiting operation is referred to as the seventh prompt information, which is not described in detail later.

It should be noted that step 601 to step 607, step 601, and step 603 to step 605 described above are optional steps, that is, the terminal executes any one or more steps, or the terminal does not execute these steps. In other words, for various kinds of prompt information related to the foregoing embodiments, the terminal displays any one or more pieces of the information or none of the information. The embodiments of the present disclosure do not limit this.

In summary, in the method for playing the video provided in the embodiments of the present disclosure, a fast multiplied-speed playing operation associated with a first multiplied playing speed is provided, such that when the video is being played, multiplied-speed playing can be quickly started in response to the fast multiplied-speed playing operation to play the video according to the first multiplied playing speed. Further, the method provides a multiplied-speed adjustment operation, such that in response to the multiplied-speed adjustment operation when the video is being played according to the first multiplied playing speed, the video can be played according to a second multiplied playing speed which corresponds to the multiplied-speed adjustment operation. Therefore, a multiplied playing speed can be quickly adjusted. The above method simplifies the operation manners for starting the multiplied-speed playing and adjusting the multiplied playing speed in the process of playing the video by providing operations easily executed via hand gestures on the region of the playing interface, and thus the method improves the operation flexibility and the operation efficiency, and effectively improves the user experience. Moreover, because the present disclosure provides a brand-new operation manner and displays prompt information on the playing interface corresponding to each operation manner, it is convenient for a user to timely and intuitively know various kinds of operations that can be performed in the process of playing the video, such that the human-computer interaction efficiency and the user experience are effectively improved, and the user stickiness is also further improved.

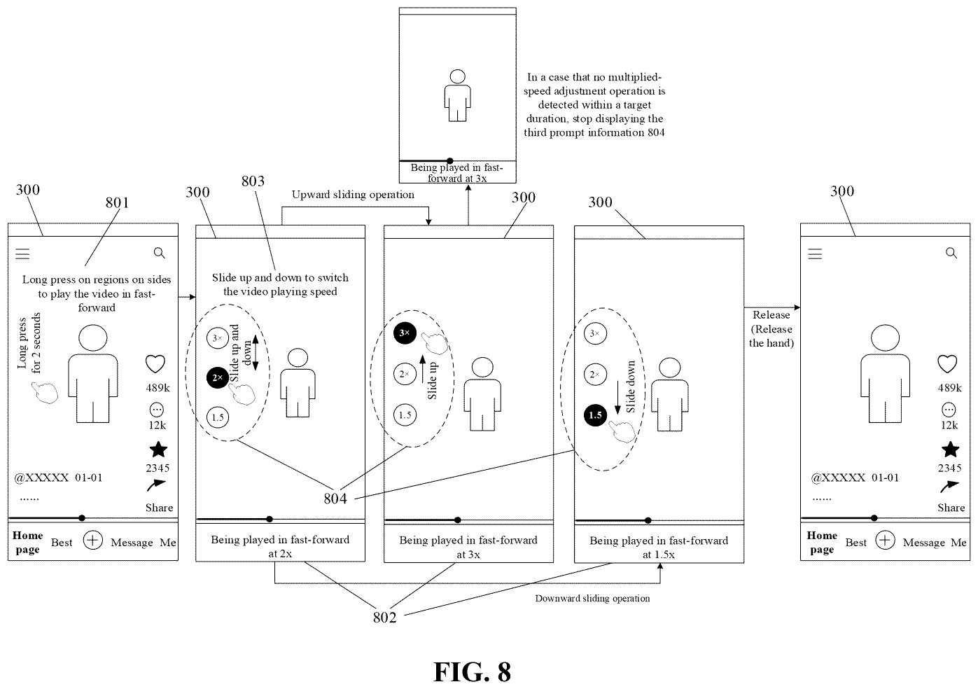

The above method for playing the video shown in FIG. 6 will be illustrated below with reference to FIG. 8 to FIG. 13. It should be understood that the above method for playing the video shown in FIG. 6 covers various implementations. What is shown in FIG. 8 to FIG. 13 is an illustration of some implementations and does not constitute a limitation on the present disclosure.

FIG. 8 is a schematic diagram of a method for playing a video, in which a multiplied-speed adjustment operation is an upward and downward sliding operation, according to some embodiments of the present disclosure. As shown in FIG. 8, the method is described by taking the following operations as an example: a long-press operation is used as a fast multiplied-speed playing operation; an upward and downward sliding operation is used as a multiplied-speed adjustment operation; and a release operation corresponding to the long-press operation is used as a multiplied-speed playing exiting operation. The flow of the operation process is described by referring to the playing interfaces in the order of from the playing interface on the left to the playing interface on the right of FIG. 8. The method for playing the video includes following step A1 to step A4 as illustrated in FIG. 8.

Step A1: referring to the first playing interface, the video is played on a playing interface 300 according to a default multiplied playing speed 1×, and target prompt information 801 “Long press on regions on sides to play the video in fast-forward” is displayed on a top region. The sides may be either a left side portion or a right side portion of the playing interface. The target prompt information prompt or instruct the target object (i.e., the user) on how to execute a fast multiplied-speed playing operation so that the video will play at a faster speed than a default multiplied playing speed.

Step A2: referring to the second playing interface, the video is played, in response to the fast multiplied-speed playing operation, namely the long-press operation (long press for two seconds), performed on the playing interface 300, according to a first multiplied playing speed 2× associated with the fast multiplied-speed playing operation. In the illustrated example, the terminal is configured such that performing the fast multiplied-speed playing operation (long press operation) results in the playing speed being faster than the default multiplied playing speed. In one example, the playing speed is increased from the default multiplied playing speed 1× to a first multiplied playing speed 2×. In addition, first prompt information 802 “Being played in fast-forward at 2×” is displayed in a bottom region of the playing interface 300, and below a progress bar in the illustrated example. Second prompt information 803 “Slide up and down to switch the video playing speeds” is displayed in the top region of the playing interface 300, which is configured to prompt the operation manner of the multiplied-speed adjustment operation.

Step A3: referring to the second, third and fourth playing interfaces, third prompt information 804 is displayed in response to the multiplied-speed adjustment operation, namely, the upward and downward sliding operation, performed on the playing interface 300, that is, an operation process corresponding to the upward and downward sliding operation is reflected by text and icons. In the illustrated example, the speed icons (e.g., 3×, 2×, and 1.5× inside the circles) are displayed). The third prompt information further includes an arrow, a text about the operation (“Slide up and down”), a hand to explain the multiplied-speed adjustment operation. In some embodiments, only the speed icons indicating the playing speeds are displayed, and the text information “Slide up and down”, the hand and the arrows are not displayed. In response to the upward sliding operation, the video is played according to a second multiplied playing speed 3× corresponding to the upward sliding operation (see the third playing interface). In some embodiments, the third prompt information 804 is stopped being displayed in a case that no multiplied-speed adjustment operation is detected within a target duration (see the top playing interface. In one example, a vibration prompt is sent according to a vibration level corresponding to the 3× speed. In response to the downward sliding operation, the video is played according to a second multiplied playing speed 1.5× corresponding to the upward sliding operation (see the fourth playing interface). In one example, a vibration prompt is sent according to a vibration level corresponding to the 1.5× speed. In this process, the first prompt information 802 “Being played in fast-forward at 3×” or “Being played in fast-forward at 1.5×” is synchronously displayed on the bottom region of the playing interface 300.

Step A4: referring to the fifth playing interface, the multiplied-speed playing is exit in response to the multiplied-speed playing exiting operation, namely, the release operation corresponding to the long-press operation, performed on the playing interface, and the video is displayed according to the default multiplied playing speed 1×.

Schematically, the long-press operation is achieved by pressing a screen of a terminal, which is taken as an example. The method for playing the video shown in FIG. 8 is understood as follows: The multiplied-speed playing is started by making long press on the screen; the multiplied playing speed is increased by upward sliding; the multiplied playing speed is decreased by downward sliding (image and text are displayed in the adjustment process for interactive representation); and the multiplied-speed playing is exit after release. Therefore, the method provides an efficient and convenient interaction manner. Long press and upward and downward sliding on the same region of the playing interface quickly starts the multiplied-speed playing and quickly adjusts the multiplied playing speed. It is not necessary to spend time and energy in performing different regions on other regions on the playing interface, such that the operation flexibility and the operation efficiency in the video playing process are effectively improved. In addition, in this process, the operation manner of starting the multiplied-speed playing and the operation manner of the multiplied-speed adjustment operation are prompted in time on the playing interface, which guides a next operation performed by a user, and it is also convenient for the user to clearly know the specific operation manner of each operation. Further, in the process of the multiplied-speed adjustment operation, vibrations with different intensities are prompted according to the multiplied playing speeds, and corresponding operation processes are displayed, such that the user visually knows the whole operation process in a visual and sensible mode, and the human-computer interaction efficiency and the user experience are effectively improved.

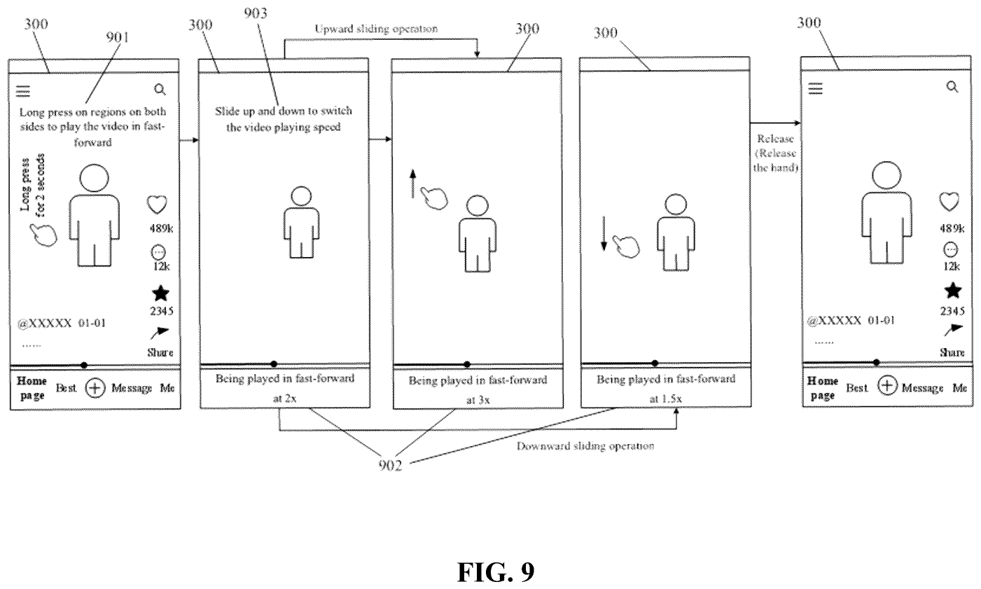

FIG. 9 is a schematic diagram of another method for playing a video, in which multiplied-speed adjustment operation is an upward and downward sliding operation, according to some embodiments of the present disclosure. As shown in FIG. 9, the method is described by taking the following operations as an example: a long-press operation is used as a fast multiplied-speed playing operation; an upward and downward sliding operation is used as a multiplied-speed adjustment operation; and a release operation corresponding to the long-press operation is used as a multiplied-speed playing exiting operation. The method for playing the video includes following step B1 to step B4. The flow of the operation process is described by referring to the playing interfaces in the order of from the playing interface on the left to the playing interface on the right of FIG. 9.

Step B1: referring to the first playing interface, the video is played on a playing interface 300 according to a default multiplied playing speed 1×, and target prompt information 901 “Long press on regions on sides to play the video in fast-forward” is displayed on a top region.

Step B2: referring to the second playing interface, the video is played, in response to the fast multiplied-speed playing operation, namely the long-press operation (long press for two seconds), performed on the playing interface 300, according to a first multiplied playing speed 2× associated with the fast multiplied-speed playing operation. In addition, first prompt information 902 “Being played in fast-forward at 2×” is displayed in a bottom region of the playing interface 300, and second prompt information 903 “Slide up and down to switch the video playing speeds” is displayed in the top region of the playing interface 300, so as to prompt the operation manner of the multiplied-speed adjustment operation.

Step B3: referring to the second, third and fourth playing interfaces, in response to the multiplied-speed adjustment operation, namely, the upward and downward sliding operation, performed on the playing interface 300, the video is played according to a corresponding second multiplied playing speed (namely, the corresponding operation process is not displayed in this process), and a vibration prompt is sent according to a vibration level corresponding to the second multiplied playing speed. In this process, the first prompt information 902, such as “Being played in fast-forward at 3×” or “Being played in fast-forward at 1.5×”, is synchronously displayed on the bottom region of the playing interface 300.

Step B4: referring to the fifth playing interface, the multiplied-speed playing is exit in response to the multiplied-speed playing exiting operation, namely, the release operation corresponding to the long-press operation, performed on the playing interface, and the video is displayed according to the default multiplied playing speed 1×.

Schematically, the long-press operation is achieved by pressing a screen of a terminal, which is taken as an example. The method for playing the video shown in FIG. 9 is understood as follows: The multiplied-speed playing is started by making long press on the screen; the multiplied playing speed is increased by upward sliding; the multiplied playing speed is decreased by downward sliding (image and text are not displayed in the adjustment process for interactive representation); and the multiplied-speed playing is exit after release. Therefore, the method provides an efficient and convenient interaction manner. Long press and upward and downward sliding on the same region of the playing interface quickly starts the multiplied-speed playing and quickly adjusts the multiplied playing speed. It is not necessary to spend time and energy in performing different regions on other regions on the playing interface, such that the operation flexibility and the operation efficiency in the video playing process are effectively improved. In addition, in this process, the operation manner of starting the multiplied-speed playing and the operation manner of the multiplied-speed adjustment operation are prompted in time on the playing interface, which guides a next operation performed by a user, and it is also convenient for the user to clearly know the specific operation manner of each operation. Further, the corresponding operation process is not displayed in the process of the multiplied-speed adjustment operation, such that the situation that excessive occupation of the playing interface by the prompt information will cover the video being played is avoided.

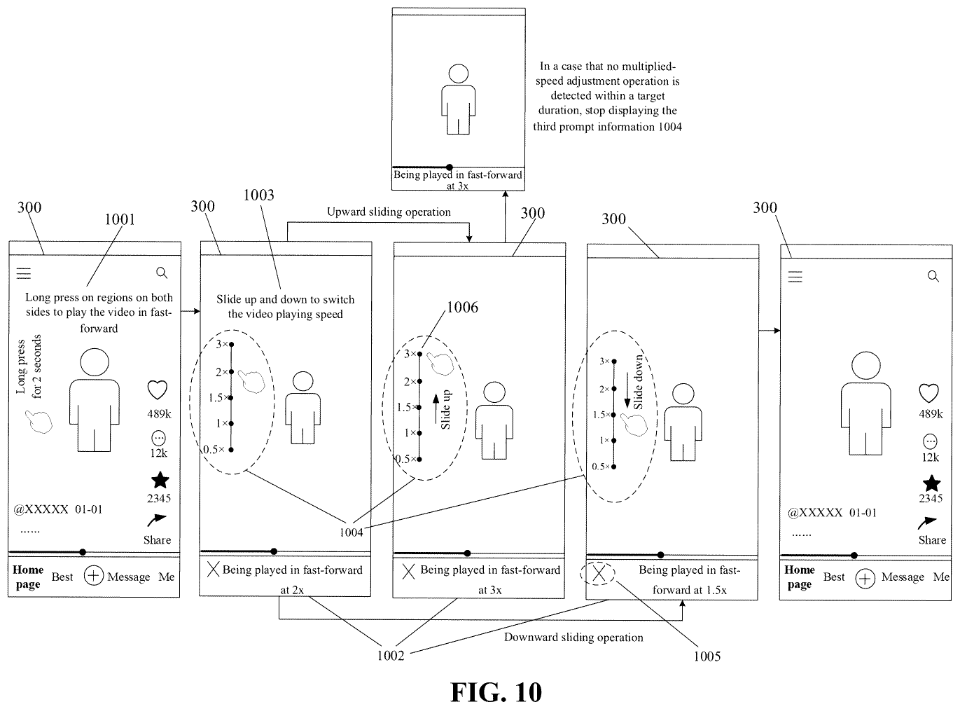

FIG. 10 is a schematic diagram of a method for playing a video, in which a multiplied-speed adjustment operation is an operation performed on a multiplied-speed adjustment track, according to some embodiments of the present disclosure. As shown in FIG. 10, the method is described by taking the following operations as an example: a long-press operation is used as a fast multiplied-speed playing operation; an operation performed on a multiplied-speed adjustment track (including a plurality of multiplied-speed levels) is used as a multiplied-speed adjustment operation; and a triggering operation performed on a multiplied-speed playing exiting control is used as a multiplied-speed playing exiting operation. The method for playing the video includes following step C1 to step C4. The flow of the operation process is described by referring to the playing interfaces in the order of from the playing interface on the left to the playing interface on the right of FIG. 10.

Step C1: referring to the first playing interface, the video is played on a playing interface 300 according to a default multiplied playing speed 1×, and target prompt information 1001 “Long press on regions on both sides to play the video in fast-forward” is displayed on a top region.

Step C2: referring to the second playing interface, the video is played, in response to the fast multiplied-speed playing operation, namely the long-press operation (long press for two seconds), performed on the playing interface 300, according to a first multiplied playing speed 2× associated with the fast multiplied-speed playing operation. In addition, first prompt information 1002 “Being played in fast-forward at 2×” is displayed in a bottom region of the playing interface 300, and second prompt information 1003 “Slide up and down to switch the video playing speeds” is displayed in the top region of the playing interface 300, so as to prompt the operation manner of the multiplied-speed adjustment operation.

Step C3: referring to the second, third and fourth playing interfaces, third prompt information 1004 is displayed in response to the multiplied-speed adjustment operation performed on the playing interface 300, namely, an upward and downward sliding operation or a click operation performed on the multiplied-speed adjustment track 1006, that is, an operation process is illustrated by text and icons. For example, in response to a triggering operation performed on any position on the playing interface 300, the multiplied-speed adjustment track 1006 is displayed. In some embodiments, the multiplied-speed adjustment track is a vertical line with the dots representing the triggering positions for the multiplied speeds on the vertical line and corresponding texts next to the dots (e.g., such as 3×, 2×, 1.5× and 0.5×). In some embodiments, the multiplied-speed adjustment track appears in a fade in manner, which is not limited. In response to sliding on the multiplied-speed adjustment track to a 3× speed, the video is played according to a second multiplied playing speed 3× (see the third playing interface). In the illustrated embodiment, the third prompt information 1004 is stopped being displayed in a case that no multiplied-speed adjustment operation is detected within a target duration (see the top playing interface). In some embodiments, a vibration prompt is sent according to a vibration level corresponding to the 3× speed. In response to sliding on the multiplied-speed adjustment track to the 1.5× speed, the video is played according to a second multiplied playing speed 1.5× (see the fourth playing interface). In some embodiments, a vibration prompt is sent according to a vibration level corresponding to the 1.5× speed. In this process, the first prompt information 1002, such as “Being played in fast-forward at 3×” or “Being played in fast-forward at 1.5×”, is synchronously displayed on the bottom region of the playing interface 300.

Step C4: referring to the fifth playing interface, the multiplied-speed playing is exit in response to the multiplied-speed playing exiting operation, namely, a triggering operation for a control 1005 for exiting the multiplied-speed playing, performed on the playing interface, and the video is displayed according to the default multiplied playing speed 1×.

Schematically, the long-press operation is achieved by pressing a screen of a terminal, which is taken as an example. The method for playing the video shown in FIG. 10 is understood as follows: the multiplied-speed playing is started by making a long press on the screen; the multiplied-speed playing still runs after release; the multiplied-speed adjustment track including a plurality of fixed multiplied-speed levels is displayed; the multiplied playing speed is adjusted by performing upward and downward sliding or clicking the corresponding multiplied-speed levels; and the multiplied-speed playing exiting control is clicked to exit the multiplied-speed playing. Therefore, the method provides an efficient, convenient and diversified interaction manner, such that a user clearly knows various optional multiplied playing speeds, and selects a favorite operation manner to adjust the multiplied playing speed. Thus, the personalized need of the user is met on the basis of improving the operation flexibility and the operation efficiency in the process of playing the video. In addition, in this process, the operation manner for starting the multiplied-speed playing and the operation manner of the multiplied-speed adjustment operation are prompted in time, which guides a next operation performed by a user, and it is also convenient for the user to clearly know the specific operation manner of each operation. Further, in the process of the multiplied-speed adjustment operation, vibrations with different intensities are prompted according to the multiplied playing speeds, and corresponding operation processes are displayed, such that the user visually knows the whole operation process in a visual and sensible mode, and the human-computer interaction efficiency and the user experience are improved.

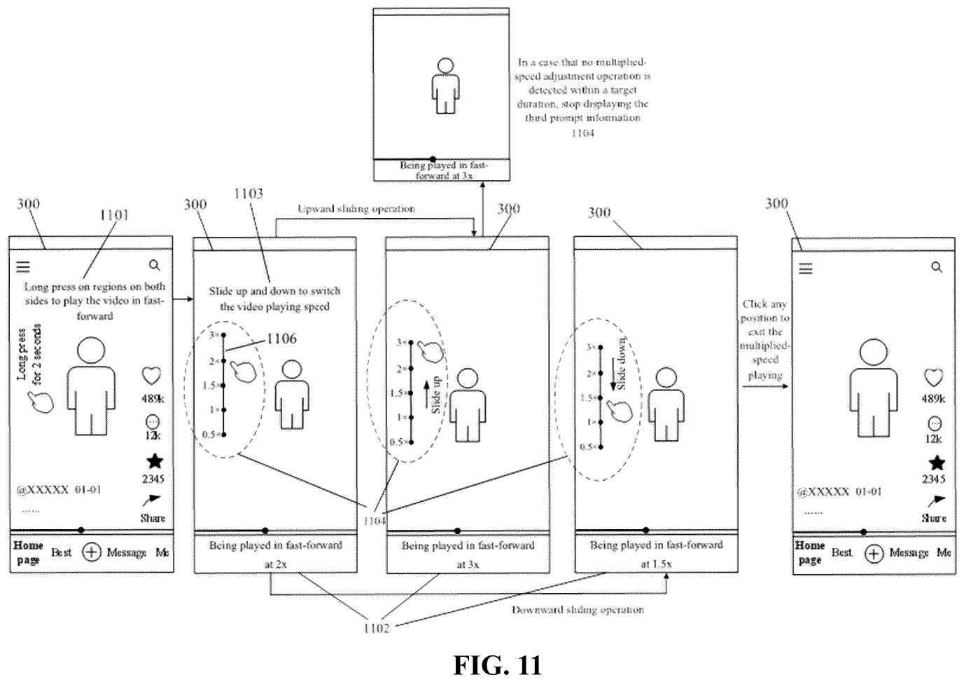

FIG. 11 is a schematic diagram of another method for playing a video, in which a multiplied-speed adjustment operation is an operation performed on a multiplied-speed adjustment track, according to some embodiments of the present disclosure. As shown in FIG. 11, the method is described by taking the following operations as an example: a long-press operation is used as a fast multiplied-speed playing operation; an operation performed on a multiplied-speed adjustment track (including a plurality of multiplied-speed levels) is used as a multiplied-speed adjustment operation; and a triggering operation performed on any position on a playing interface is used as a multiplied-speed playing exiting operation. The method for playing the video includes following step D1 to step D4. The flow of the operation process is described by referring to the playing interfaces in the order of from the playing interface on the left to the playing interface on the right of FIG. 11.

Step D1: referring to the first playing interface, the video is played on a playing interface 300 according to a default multiplied playing speed 1×, and target prompt information 1101 “Long press on regions on sides to play the video in fast-forward” is displayed on a top region.

Step D2: referring to the second playing interface, the video is played, in response to the fast multiplied-speed playing operation, namely the long-press operation (long press for two seconds), performed on the playing interface 300, according to a first multiplied playing speed 2× associated with the fast multiplied-speed playing operation. In addition, first prompt information 1102 “Being played in fast-forward at 2×” is displayed in a bottom region of the playing interface 300, and second prompt information 1103 “Slide up and down to switch the video playing speeds” is displayed in the top region of the playing interface 300, so as to prompt the operation manner of the multiplied-speed adjustment operation.

Step D3: referring to the second, third and fourth playing interfaces, third prompt information 1104 is displayed in response to the multiplied-speed adjustment operation performed on the playing interface 300, namely, an upward and downward sliding operation performed on the multiplied-speed adjustment track 1106, that is, an operation process is display as text and icons. In the illustrated example, in response to a triggering operation performed on any position on the playing interface 300, the multiplied-speed adjustment track is displayed (for example, the multiplied-speed adjustment track appears in a fade in manner, which is not limited). In response to sliding on the multiplied-speed adjustment track to a 3× speed, the video is played according to a second multiplied playing speed 3× (see the third playing interface). In some embodiments, the third prompt information 1104 is stopped being displayed in a case that no multiplied-speed adjustment operation is detected within a target duration (see the top playing interface). In some embodiments, a vibration prompt is sent according to a vibration level corresponding to the 3× speed. In response to sliding on the multiplied-speed adjustment track to the 1.5× speed, the video is played according to a second multiplied playing speed 1.5× (see the fourth playing interface). In some embodiments, a vibration prompt is sent according to a vibration level corresponding to the 1.5× speed. In this process, the first prompt information 1102, such as “Being played in fast-forward at 3×” or “Being played in fast-forward at 1.5×”, is synchronously displayed on the bottom region of the playing interface 300.

Step D4: referring to the fifth playing interface, the multiplied-speed playing is exit in response to the multiplied-speed playing exiting operation. In the illustrated example, the exit operation is a triggering operation performed on any position on the playing interface. In response to the trigger operation, the video is displayed according to the default multiplied playing speed 1×.

Schematically, the long-press operation is achieved by pressing a screen of a terminal, which is taken as an example. The method for playing the video shown in FIG. 11 is understood as follows: the multiplied-speed playing is started by making a long press on the screen; the multiplied-speed adjustment track including a plurality of fixed multiplied-speed levels is displayed; the multiplied playing speed is adjusted by performing upward and downward sliding to the corresponding multiplied-speed levels; and any position is clicked to exit the multiplied-speed playing. Therefore, the method provides an efficient and convenient interaction manner, the user not only clearly knows various optional multiplied playing speeds, but also achieves the entire operation flow on the basis of a series of simple operations, such that the operation flexibility and the operation efficiency in the process of playing the video are effectively improved. In addition, in this process, the operation manner for starting the multiplied-speed playing and the operation manner of the multiplied-speed adjustment operation are prompted in time, which guides a next operation performed by a user, and it is also convenient for the user to clearly know the specific operation manner of each operation. Further, in the process of the multiplied-speed adjustment operation, vibrations with different intensities are prompted according to the multiplied playing speeds, and corresponding operation processes are displayed, such that the user visually knows the whole operation process in a visual and sensible mode, and the human-computer interaction efficiency and the user experience are improved.

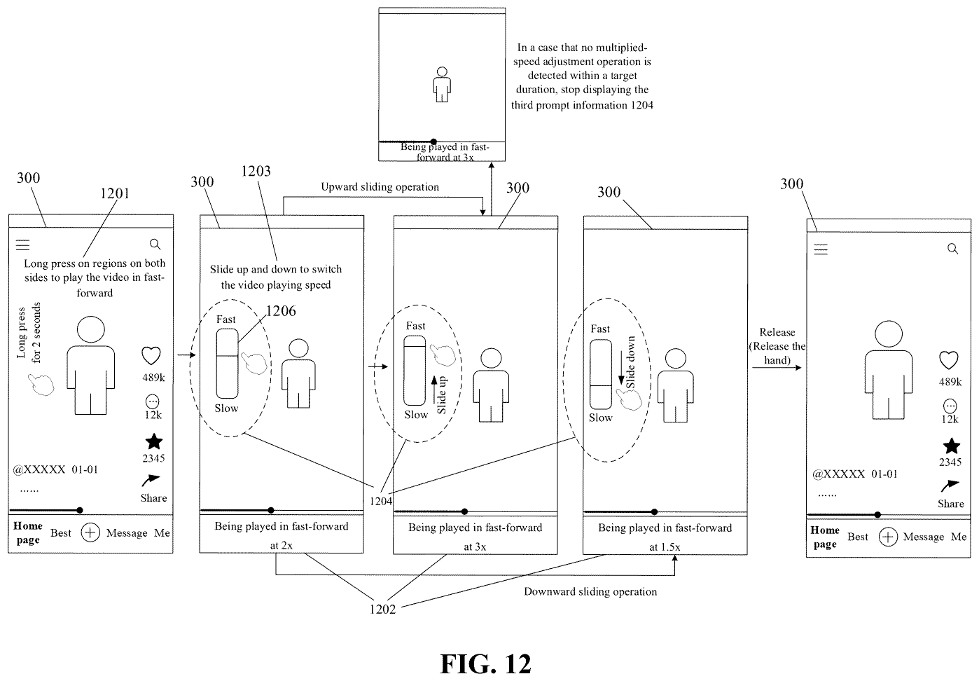

FIG. 12 is a schematic diagram of still another method for playing a video, in which a multiplied-speed adjustment operation is an operation performed on a multiplied-speed adjustment track, according to some embodiments of the present disclosure. As shown in FIG. 12, the method is described by taking the following operations as an example: a long-press operation is used as a fast multiplied-speed playing operation; an operation performed on a multiplied-speed adjustment track is used as a multiplied-speed adjustment operation (two ends of the multiplied-speed adjustment rack respectively indicate an upper limit and a lower limit of adjustment of a multiplied playing speed); and a release operation corresponding to the long-press operation is used as a multiplied-speed playing exiting operation. The method for playing the video includes following step E1 to step E4. The flow of the operation process is described by referring to the playing interfaces in the order of from the playing interface on the left to the playing interface on the right of FIG. 12.

Step E1: referring to the first playing interface, the video is played on a playing interface 300 according to a default multiplied playing speed 1×, and target prompt information 1201 “Long press on regions on both sides to play the video in fast-forward” is displayed on a top region.

Step E2: referring to the second playing interface, the video is played, in response to the fast multiplied-speed playing operation, namely the long-press operation (long press for two seconds), performed on the playing interface 300, according to a first multiplied playing speed 2× associated with the fast multiplied-speed playing operation. In addition, first prompt information 1202 “Being played in fast-forward at 2×” is displayed in a bottom region of the playing interface 300, and second prompt information 1203 “Slide up and down to switch the video playing speeds” is displayed in the top region of the playing interface 300, so as to prompt the operation manner of the multiplied-speed adjustment operation.

Step E3: referring to the second, third and fourth playing interfaces, third prompt information 1204 is displayed in response to the multiplied-speed adjustment operation performed on the playing interface 300. The third prompt information is prompt information on how to perform the multiplied-speed adjustment operation. In the illustrated example, the multiplied-speed adjustment operation is an upward and downward sliding operation performed on the multiplied-speed adjustment track 1206. The multiplied-speed adjustment track 1206 is a vertical hollow bar with a moveable mark inside the hollow bar. On the top end of the hollow bar, a text “Fast” is displayed. On the bottom end of the hollow bar, a text “Slow” is displayed. That is, an operation process is reflected and described by text and icons, In response to a triggering operation performed on any position on a playing interface 300, the multiplied-speed adjustment track 1206 is displayed (in one example, the multiplied-speed adjustment track may appear in a fade in manner). In response to sliding up on the multiplied-speed adjustment track 1206 to any position or the in response to the movement of the moveable mark inside the hollow bar, the video is played according to a second multiplied playing speed 3× corresponding to this position (see the third playing interface). In some embodiments, the third prompt information 1204 is stopped being displayed in a case that no multiplied-speed adjustment operation is detected within a target duration (see the top playing interface). In some embodiments, a vibration prompt is sent. In response to sliding down on the multiplied-speed adjustment track to the 1.5× speed, the video is played according to a second multiplied playing speed 1.5×. In some embodiments, a vibration prompt is sent according to a vibration level corresponding to the 1.5× speed. In this process, the first prompt information 1202, such as “Being played in fast-forward at 3×” or “Being played in fast-forward at 1.5×”, is synchronously displayed on the bottom region of the playing interface 300.

Step E4: referring to the fifth playing interface, the multiplied-speed playing is exit in response to the multiplied-speed playing exiting operation, namely, the release operation corresponding to the long-press operation, performed on the playing interface, and the video is displayed according to the default multiplied playing speed 1×.

Schematically, the long-press operation is achieved by pressing a screen of a terminal, which is taken as an example. The method for playing the video shown in FIG. 12 is understood as follows: The multiplied-speed playing is started by making long press on the screen; the multiplied-speed adjustment track is displayed; the multiplied playing speed is adjusted by performing upward and downward sliding to any position (image and text are displayed in the adjustment process for interactive representation); and the multiplied-speed playing is exit after release. Therefore, the method provides an efficient and convenient interaction mode capable of meeting the personalized need of the user, and the user selects any multiplied playing speed according to a preference of the user, such that the operation flexibility in the process of playing the video and the user experience are effectively improved. In addition, in this process, the operation manner for starting the multiplied-speed playing and the operation manner of the multiplied-speed adjustment operation are prompted in time, which guides a next operation performed by a user, and it is also convenient for the user to clearly know the specific operation manner of each operation. Further, in the process of the multiplied-speed adjustment operation, vibrations with different intensities are prompted according to the multiplied playing speeds, and corresponding operation processes are displayed, such that the user visually knows the whole operation process in a visual and sensible mode, and the human-computer interaction efficiency and the user experience are improved.

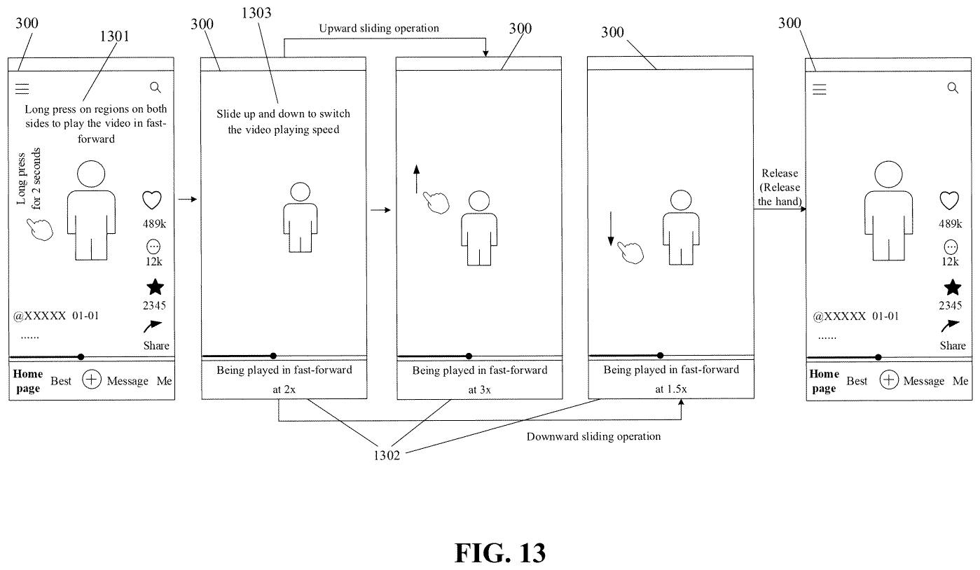

FIG. 13 is a schematic diagram of yet another method for playing a video, in which a multiplied-speed adjustment operation is an operation performed on a multiplied-speed adjustment track, according to some embodiments of the present disclosure. As shown in FIG. 13, the method is described by taking the following operations as an example: a long-press operation is used as a fast multiplied-speed playing operation; an operation performed on a multiplied-speed adjustment track is used as a multiplied-speed adjustment operation (two ends of the multiplied-speed adjustment rack respectively indicate an upper limit and a lower limit of adjustment of a multiplied playing speed); and a release operation corresponding to the long-press operation is used as a multiplied-speed playing exiting operation. The method for playing the video includes following step F1 to step F4. The flow of the operation process is described by referring to the playing interfaces in the order of from the playing interface on the left to the playing interface on the right of FIG. 13.

Step F1: The video is played on a playing interface 300 according to a default multiplied playing speed 1×, and target prompt information 1301 “Long press on regions on both sides to play the video in fast-forward” is displayed on a top region.

Step F2: The video is played, in response to the fast multiplied-speed playing operation, namely the long-press operation (long press for two seconds), performed on the playing interface 300, according to a first multiplied playing speed 2× associated with the fast multiplied-speed playing operation. In addition, first prompt information 1302 “Being played in fast-forward at 2×” is displayed in a bottom region of the playing interface 300, and second prompt information 1303 “Slide up and down to switch the video playing speeds” is displayed in the top region of the playing interface 300, so as to prompt the operation manner of the multiplied-speed adjustment operation.

Step F3: In response to the multiplied-speed adjustment operation, namely, the upward and downward sliding operation performed on the playing interface 300, the video is played according to a corresponding second multiplied playing speed (namely, the corresponding operation process is not displayed in this process), and a vibration prompt is sent. In this process, the first prompt information 1302, such as “Being played in fast-forward at 3×” or “Being played in fast-forward at 1.5×”, is synchronously displayed on the bottom region of the playing interface 300.

Step F4: The multiplied-speed playing is exit in response to the multiplied-speed playing exiting operation, namely, the release operation corresponding to the long-press operation, performed on the playing interface, and the video is displayed according to the default multiplied playing speed 1×.

Schematically, the long-press operation is achieved by pressing a screen of a terminal, which is taken as an example. The method for playing the video shown in FIG. 13 is understood as follows: The multiplied-speed playing is started by making long press on the screen, the multiplied playing speed is adjusted by performing upward and downward sliding to any position (image and text are not displayed in the adjustment process for interactive representation); and the multiplied-speed playing is exit after release. Therefore, the method provides an efficient and convenient interaction mode capable of meeting the personalized need of the user, and the user selects any multiplied playing speed according to a preference of the user, such that the operation flexibility in the process of playing the video and the user experience are effectively improved. In addition, in this process, the operation manner for starting the multiplied-speed playing and the operation manner of the multiplied-speed adjustment operation are prompted in time, which guides a next operation performed by a user, and it is also convenient for the user to clearly know the specific operation manner of each operation. Further, the corresponding operation process is not displayed in the process of the multiplied-speed adjustment operation, such that the situation that excessive occupation of the playing interface by the prompt information will cover the video being played is avoided.

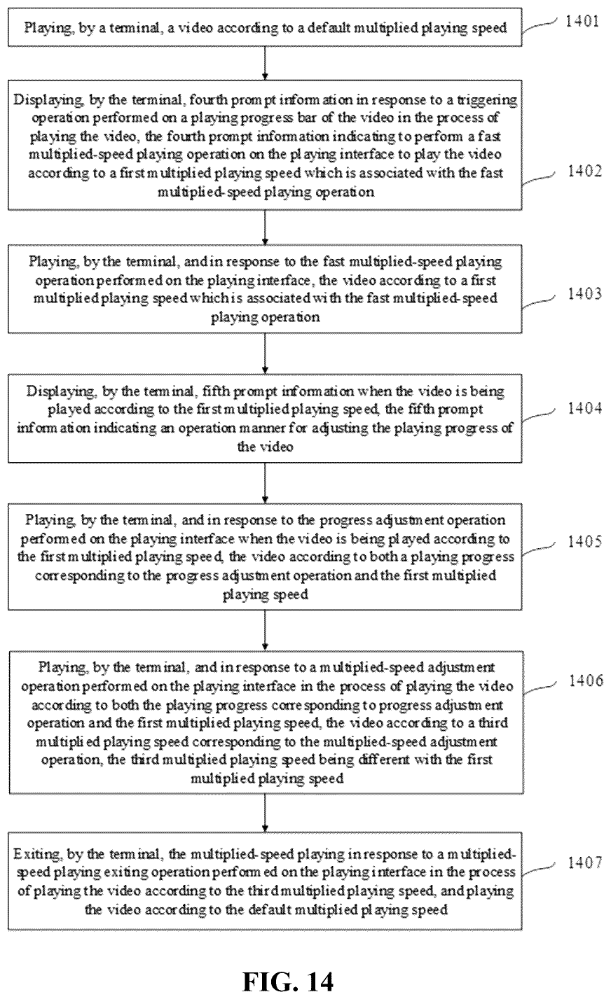

According to those shown in FIG. 6 to FIG. 13, the method for playing the video provided by the present disclosure has been described in detail. In the above method, the operation manner for fast starting the multiplied-speed playing is reminded by displaying the corresponding prompt information in the process of playing the video. In some other embodiments, the present disclosure further provides a method for playing a video, an operation manner for fast starting multiplied-speed playing is reminded by displaying corresponding prompt information in the process of adjusting a playing progress. Furthermore, in the process of the multiplied-speed playing of the video, an operation manner for adjusting the playing progress is reminded by displaying corresponding prompt information, such that interactive guidance between different video playing functions is achieved, the flexibility and efficiency of related operations in the process of playing the video are further improved, and the user experience is improved. This method is described below with reference to the embodiments of FIG. 14.

FIG. 14 is a flowchart of still another method for playing a video according to some embodiments of the present disclosure. As shown in FIG. 14, the method is performed by a terminal, and includes following step 1401 to step 1407.

In step 1401, the terminal plays the video according to a default multiplied playing speed.

In step 1402, the terminal displays fourth prompt information in response to a triggering operation performed on a playing progress bar of the video in the process of playing the video. The fourth prompt information indicates to perform a fast multiplied-speed playing operation on the playing interface to play the video according to a first multiplied playing speed which is associated with the fast multiplied-speed playing operation.

The playing progress bar is configured to adjust a playing progress of the video, and the triggering operation performed on the playing progress bar is, for example, a click operation, a dragging operation, or the like performed on any position on the playing progress bar, which is not limited in the present disclosure. In addition, a displaying position and a displaying form of the fourth prompt information on the playing interface are not limited in the present disclosure. For example, the terminal displays the fourth prompt information as text information “Long press on regions on sides to play the video in fast-forward” on a top region of the playing interface. For another example, the terminal displays the fourth prompt information as text information “Slide upward to enter the multiplied-speed playing” (that is, the fast multiplied-speed playing operation is an upward sliding operation) on a region above the playing progress bar. It should be noted that the fourth prompt information is a general term. In the embodiments of the present disclosure, prompt information defined to indicate the fast multiplied-speed playing operation when the playing progress bar is triggered is collectively referred to as the fourth prompt information, which is not described in detail later.

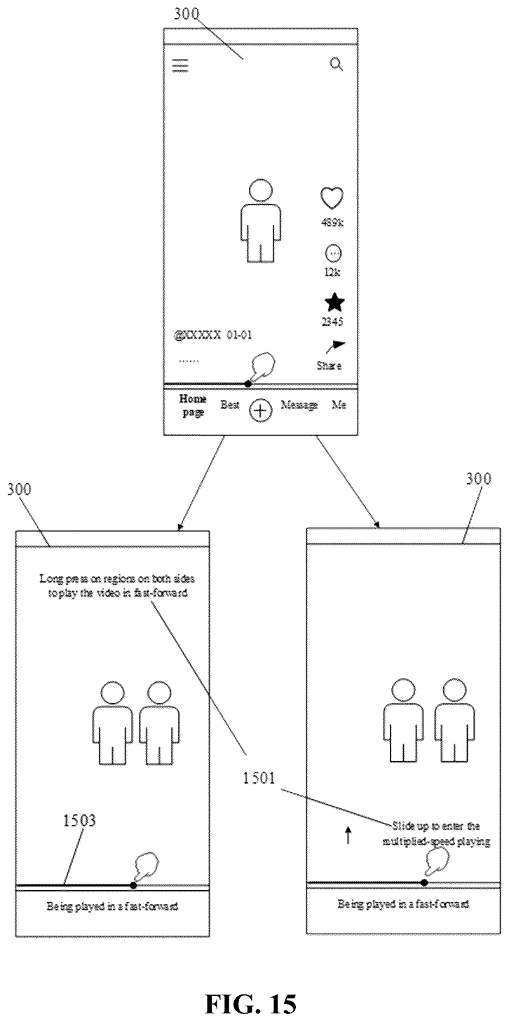

Schematically, referring to FIG. 15, FIG. 15 is a schematic diagram of fourth prompt information according to some embodiments of the present disclosure. As shown in FIG. 15, a terminal plays a video according to a default multiplied playing speed on a playing interface 300, and displays, in response to a triggering operation performed on a playing progress bar 1503, fourth prompt information 1501 “Long press on regions on both sides to play the video in fast-forward” on a top region of the playing interface 300; or displays fourth prompt information 1501 “Slide upward to enter the multiplied-speed playing” on a region above the playing progress bar in the playing interface 300. It should be understood that the terminal may also display a plurality of pieces of fourth prompt information synchronously, which is not limited in the present disclosure.

In step 1403, the terminal plays, in response to the fast multiplied-speed playing operation performed on the playing interface, the video according to a first multiplied playing speed which is associated with the fast multiplied-speed playing operation.

For the specific implementation of this step, refer to the embodiments shown in FIG. 6 described above, and repeated description will be omitted here.

In step 1404, the terminal displays fifth prompt information when the video is being played according to the first multiplied playing speed. The fifth prompt information indicates an operation manner for adjusting the playing progress of the video.

The operation manner for adjusting the playing progress is also a progress adjustment operation. The specific implementation of the progress adjustment operation will be described in detail in step 1405 below, and descriptions thereof are omitted here. In addition, a displaying position and a displaying form of the fifth prompt information on the playing interface are not limited in the present disclosure. For example, a leftward and rightward sliding operation is used as the progress adjustment operation, which is taken as an example. The terminal displays fifth prompt information as text information “Slide left and right to adjust the video playing progress” on the top region of the playing interface. It should be noted that the fifth prompt information is a general term. In the embodiments of the present disclosure, prompt information defined to indicate an operation manner for adjusting the playing progress is referred to as the fifth prompt information, which is not described in detail later.

In step 1405, the terminal plays, in response to the progress adjustment operation performed on the playing interface when the video is being played according to the first multiplied playing speed, the video according to both a playing progress corresponding to the progress adjustment operation and the first multiplied playing speed.

The terminal determines, in response to the progress adjustment operation, the playing progress corresponding to the progress adjustment operation, and continues to play the video on the basis of the playing progress and according to the first multiplied playing speed. In some embodiments, the terminal displays, in response to the progress adjustment operation, the operation process corresponding to the progress adjustment operation. This manner is the same as the third prompt information in the embodiments shown in FIG. 6, and the descriptions thereof are omitted here. It should be understood that the description is made by taking the process of playing the video according to the first multiplied playing speed as an example. In the process of playing the video according to another multiplied playing speed, the terminal also makes a response to the progress adjustment operation in the same way, and descriptions thereof are omitted here.

Schematically, implementation of the progress adjustment operation includes at least one of the following.

A first progress adjustment operation: a sliding operation towards a preset direction.

Schematically, the progress adjustment operation includes at least one of: sliding towards a third direction; and sliding towards a fourth direction. The third direction is opposite to the fourth direction, and the third direction and the fourth direction respectively correspond to different adjustment directions of the playing progress. For example, the third direction is rightward, which corresponds to forward adjustment of the playing progress to the video content appearing later in the video than the current progress, and the fourth direction is to leftward, which corresponds to backward adjustment of the playing progress to the video content appearing earlier in the video than the current progress, which is not limited in the present disclosure. It should be noted that the implementation of the multiplied-speed adjustment operation is an operation of sliding towards the preset direction (namely, sliding towards the first direction or the second direction), the third direction and the fourth direction corresponding to the progress adjustment operation are different with both the first direction and the second direction. For example, if the multiplied-speed adjustment operation is the upward and downward sliding operation, the progress adjustment operation is the leftward and rightward sliding operation, and the present disclosure is not limited thereto. The progress adjustment operation is achieved by performing the sliding operation towards the preset direction. The operation manner for adjusting the playing progress is simplified, and the operation flexibility and the operation efficiency are improved. In other words, the present disclosure provides a simple operation manner to achieve the adjustment of the playing progress in the multiplied-speed playing process. For example, in a case that a target object wants to watch a video content after a current progress, the target object adjusts the progress to a position behind the playing progress by simply sliding the progress bar to the right (forward adjustment of the video); and in a case that the target object wants to watch a video content before the current progress, the target object adjusts the progress to a position ahead the playing progress by simply sliding the progress bar to the left (backward adjustment of the video). This greatly simplifies the operation manner and meets needs of users for adjusting the playing progress conveniently at any time. The progress adjustment operation may be performed on any region or a target region on the playing interface.

In some embodiments, the terminal determines, in response to the progress adjustment operation on the basis of a sliding amplitude corresponding to the progress adjustment operation, the playing progress corresponding to the progress adjustment operation. The sliding amplitude indicates an adjustment amplitude of the playing progress. That is, a larger the sliding amplitude indicates a larger adjustment amplitude of the playing progress. For example, the leftward a rightward sliding operation used as the progress adjustment operation is taken as an example. A total duration of the video is 10 minutes, and a current playing progress is 5 minutes. In a case that a sliding amplitude corresponding to the rightward sliding operation is 0.5 cm, the adjustment amplitude is forward adjustment for 1 minute, and the terminal continues to play the video from the sixth minute. In a case that the sliding amplitude corresponding to the rightward sliding operation is 1 cm, the adjustment amplitude is forward adjustment for 2 minutes, and the terminal continues to play the video from the seventh minute at the same playing speed. It should be understood that the examples of the sliding amplitude and the adjustment amplitude are only illustrative and are also implemented in other ways, and the present disclosure is not limited thereto.

In some embodiments, there is an overlapping region between an implementation region of the progress adjustment operation and an implementation region of the fast multiplied-speed playing operation, and there is also an overlapping region between the implementation region of the progress adjustment operation and an implementation region of the multiplied-speed adjustment operation. For example, the implementation region of the fast multiplied-speed playing operation is on the left hand side of the playing interface. The target object performs the fast multiplied-speed playing operation (such as a long-press operation) on this region to trigger the terminal to start the multiplied-speed playing. The target object continues to perform the simple multiplied-speed adjustment operation (such as an upward and downward sliding operation) on this region to trigger the terminal to adjust the multiplied playing speed. The target object also continues to perform the simple progress adjustment operation (such as a leftward and rightward sliding operation) on this region to trigger the terminal to adjust the playing progress. Therefore, the progress adjustment operation provided in the present disclosure greatly improves the operation efficiency by performing different operations on one region of the playing interface. That is, on the same region or the target region, a user can fast start the multiplied-speed playing, then adjusts the multiplied playing speed using one kind of gesture, and then adjusts the playing progress using another kind of gesture, such that seamless connection between different playing functions is achieved. Furthermore, as different operations are performed on the same region, coverage of video contents on the playing interface is reduced, and the user experience is greatly improved.

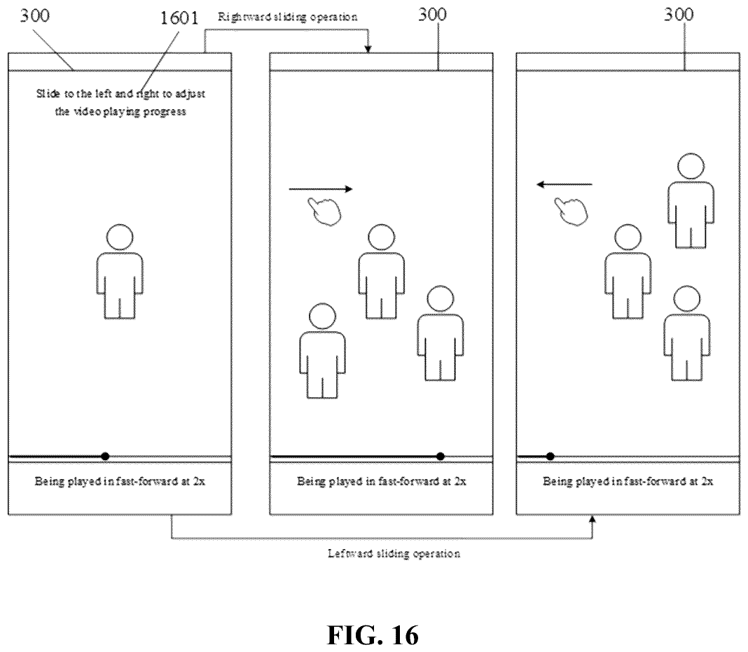

Schematically, referring to FIG. 16, FIG. 16 is a schematic diagram of a progress adjustment operation performed on a region of a playing interface according to some embodiments of the present disclosure. As shown in FIG. 16, a leftward and rightward sliding operation on the playing interface used as the progress adjustment operation is taken as an example. A terminal displays, when the video is being played according to a first multiplied playing speed 2×, fifth prompt information 1601 “Slide to the left and right to adjust the video playing progress” on a top region of a playing interface 300, and plays, in response to a rightward sliding operation performed on the playing interface 300, the video according to both a playing progress corresponding to the rightward sliding operation and the first multiplied playing speed. The terminal plays, in response to a leftward sliding operation performed on the playing interface 300, the video according to both a playing progress corresponding to the leftward sliding operation and the first multiplied playing speed.

Alternatively or additionally, a progress adjustment operation may be an operation performed on the playing progress bar of the video.

Schematically, the progress adjustment operation performed on the progress bar includes at least one of: a dragging operation performed on the playing progress bar; and a triggering operation performed on any position on the playing progress bar. That is, a target object selects any playing progress by performing the dragging operation on the playing progress bar or the triggering operation on any position on the playing progress bar, so as to trigger the terminal to play the video according to a corresponding playing progress. In this way, the personalized need of the target object for adjusting the playing progress is met, such that the user experience is improved.

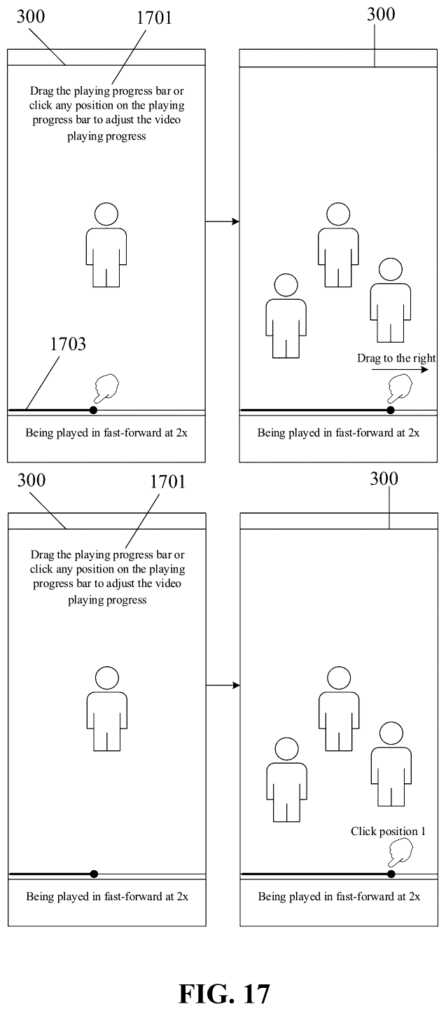

Schematically, referring to FIG. 17, FIG. 17 is a schematic diagram of a progress adjustment operation performed on a progress bar 1703 according to some embodiments of the present disclosure. As shown in the top two playing interfaces in FIG. 17, a terminal displays, when the video is being played according to a first multiplied playing speed 2×, fifth prompt information 1701 “Drag the playing progress bar or click any position on the playing progress bar to adjust the video playing progress” on a top region of the playing interface 300; the terminal plays, in response to the dragging operation performed on the playing progress bar 1703, the video according to a playing progress corresponding to the dragging operation and the first multiplied playing speed. As shown in the bottom two playing interfaces in FIG. 17, the terminal displays, when the video is being played according to a first multiplied playing speed 2×, fifth prompt information 1701 “Drag the playing progress bar or click any position on the playing progress bar to adjust the video playing progress” on a top region of the playing interface 300; the terminal plays, in response to the triggering operation performed on position 1 on the playing progress bar, the video according to both a playing progress corresponding to the click position 1 and the first multiplied playing speed.

In some embodiments, the terminal displays sixth prompt information in response to the progress adjustment operation. The sixth prompt information indicates a playing progress corresponding to the progress adjustment operation. A displaying position and a displaying form of the sixth prompt information on the playing interface are not limited in the present disclosure. For example, a total duration of the video is 10 minutes, which is as an example. In a case that a playing progress corresponding to the progress adjustment operation is the fifth minute, the terminal displays text sixth prompt information “05:00” on a region below the playing progress bar on the playing interface, or the terminal displays image sixth prompt information, namely, a thumbnail of the video, on a region above the playing progress bar on the playing interface. The thumbnail is a video picture of the video at the fifth minute. In some embodiments, the terminal also displays the sixth prompt information as text information and the sixth prompt information as image information synchronously, which is not limited in the present disclosure. It should be understood that the terminal continuously displays the sixth prompt information in the process of responding to the progress adjustment operation, that is, the terminal continuously displays the sixth prompt information according to the playing progress corresponding to the progress adjustment operation. In some embodiments, the terminal displays the sixth prompt information in a case that the progress adjustment operation is finished. The present disclosure is not limited thereto. As the sixth prompt information is displayed on the playing interface, the playing progress corresponding to the progress adjustment operation is prompted in time, such that a user clearly knows the detailed playing progress, and the human-computer interaction efficiency and the user experience are improved. It should be noted that the sixth prompt information is a general term. In the embodiments of the present disclosure, prompt information defined to indicate a playing progress corresponding to the progress adjustment operation is referred to as the sixth prompt information, which is not described in detail later.

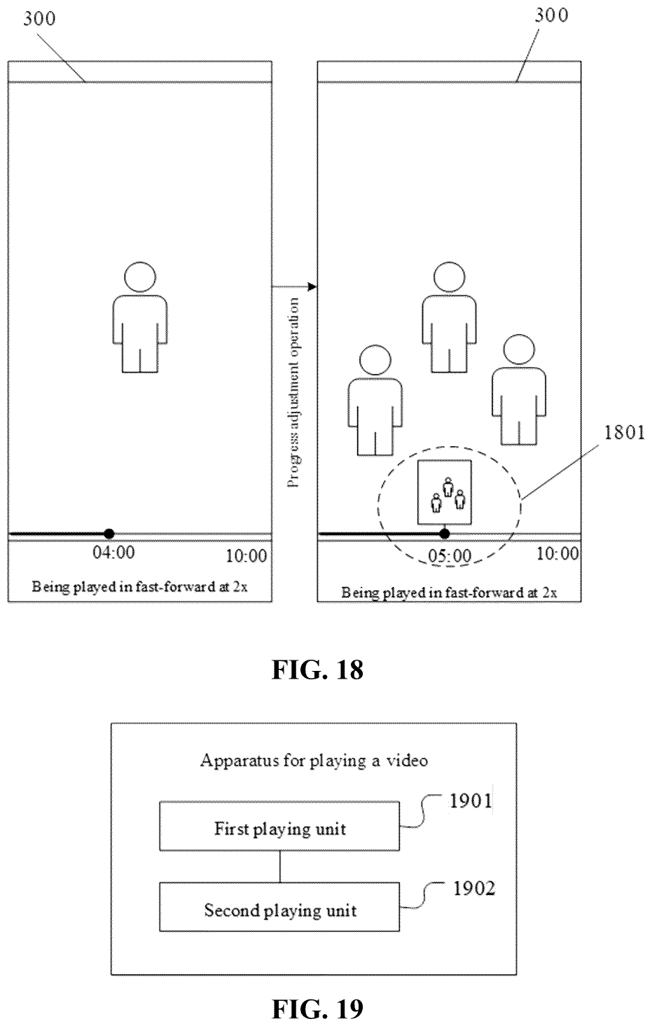

Schematically, referring to FIG. 18, FIG. 18 is a schematic diagram of sixth prompt information according to some embodiments of the present disclosure. As shown in FIG. 18, a terminal plays a video according to a first multiplied playing speed on a playing interface. A total duration of the video is 10 minutes, and a current video playing progress is the fourth minute. In response to a playing progress of the fifth minute corresponding to the progress adjustment operation, the terminal displays sixth prompt information 1801 as text information “05:00” on a region below the playing progress bar on the playing interface and as image information, (i.e., a thumbnail of a video picture of the video at the fifth minute), on a region above the playing progress bar on the playing interface.

In step 1406, the terminal plays, in response to a multiplied-speed adjustment operation performed on the playing interface in the process of playing the video according to both the playing progress corresponding to progress adjustment operation and the first multiplied playing speed, the video according to a third multiplied playing speed corresponding to the multiplied-speed adjustment operation. The third multiplied playing speed is different with the first multiplied playing speed.

For the specific implementation of the multiplied-speed adjustment operation, refer to the embodiments shown in FIG. 2 and FIG. 6 described above, and repeated description will be omitted here. Schematically, after the terminal adjusts the playing progress in the multiplied-speed playing process, the terminal plays, on the basis of the multiplied-speed adjustment operation performed by the target object on the playing interface, the video according to the third multiplied playing speed corresponding to the multiplied-speed adjustment operation, such that seamless connection among these functions such as the multiplied-speed playing, the playing progress adjustment, and the multiplied playing speed adjustment is achieved; the operation manners of the various operations in the process of playing the video are simplified; and the operation flexibility and the operation efficiency are improved.

In step 1407, the terminal exits the multiplied-speed playing in response to a multiplied-speed playing exiting operation performed on the playing interface in the process of playing the video according to the third multiplied playing speed, and plays the video according to the default multiplied playing speed.

It should be noted that step 1401 to step 1407 are shown as an optional implementation provided by the present disclosure. For the multiplied-speed playing process involved in the method for playing the video, refer to the foregoing embodiments shown in FIG. 2 and FIG. 6, and descriptions thereof are omitted here.

It can be seen that the video playing method shown in FIG. 14 provides a manner for displaying corresponding prompt information to prompt the start of the multiplied-speed playing in the process of adjusting the playing progress, and further, an operation manner of adjusting the playing progress is prompted by displaying corresponding prompt information in the process of multiplied-speed playing, further, after the playing progress is adjusted, the playing double-speed can be adjusted, so that interactive guidance between different video playing functions and seamless connection between different playing functions are realized, the flexibility and the operation efficiency of relevant operations of video playing are further improved, and the user experience is improved.

FIG. 19 is a block diagram of an apparatus for playing a video according to some embodiments of the present disclosure. Referring to FIG. 19, the apparatus includes a first playing unit 1901 and a second playing unit 1902.

The first playing unit 1901 is configured to play, in response to a fast multiplied-speed playing operation performed on a playing interface of the video when the video is being played, the video according to a first multiplied playing speed which is associated with the fast multiplied-speed playing operation.

The second playing unit 1902 is configured to play, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.

The above apparatus provides a fast multiplied-speed playing operation associated with a first multiplied playing speed, such that when the video is being played, multiplied-speed playing is quickly started in response to the fast multiplied-speed playing operation to play the video according to the first multiplied playing speed. Further, the method further provides a multiplied-speed adjustment operation, such that in response to the multiplied-speed adjustment operation when the video is being played according to the first multiplied playing speed, the video is played according to a second multiplied playing speed which corresponds to the multiplied-speed adjustment operation. Therefore, a multiplied playing speed is quickly adjusted. This apparatus simplifies the operation manners for starting the multiplied-speed playing and adjusting the multiplied playing speed in the process of playing the video, improves the operation flexibility and the operation efficiency, and effectively improves the user experience.

In some embodiments, the multiplied-speed adjustment operation includes at least one of: sliding towards a first direction; and sliding towards a second direction. The first direction is opposite to the second direction, and the first direction and the second direction respectively correspond to different multiplied playing speeds.

In some embodiments, the multiplied-speed adjustment operation refers to an operation performed on a multiplied-speed adjustment track, and the multiplied-speed adjustment track indicates a plurality of multiplied playing speeds.

In some embodiments, the multiplied-speed adjustment track includes a plurality of multiplied-speed levels, and the different multiplied-speed levels respectively correspond to different multiplied playing speeds. The multiplied-speed adjustment operation includes at least one of: a triggering operation performed on the multiplied-speed levels; and sliding on the multiplied-speed adjustment track to reach one of the multiplied-speed levels.

In some embodiments, two ends of the multiplied-speed adjustment track respectively indicate an upper limit and a lower limit of adjustment of a multiplied playing speed. The multiplied-speed adjustment operation includes at least one of: a triggering operation performed on any position on the multiplied-speed adjustment track; and sliding on the multiplied-speed adjustment track to reach any position.

In some embodiments, the apparatus further includes: a vibration unit, configured to send, in response to the multiplied-speed adjustment operation, a vibration prompt according to a vibration level corresponding to the second multiplied playing speed.

In some embodiments, the apparatus further includes: a first displaying unit, configured to display first prompt information when the video is being played according to the first multiplied playing speed. The first prompt information indicates a current multiplied playing speed of the video.

In some embodiments, the apparatus further includes: a second displaying unit, configured to display second prompt information when the video is being played according to the first multiplied playing speed. The second prompt information indicates an operation manner of a multiplied-speed adjustment operation.

In some embodiments, the apparatus further includes: a third displaying unit, configured to display third prompt information in response to the multiplied-speed adjustment operation. The third prompt information indicates an operation process corresponding to the multiplied-speed adjustment operation.

In some embodiments, the first playing unit 1901 is configured to play, in response to the fast multiplied-speed playing operation performed on a target region of the playing interface in the process of playing the video, the video according to the first multiplied playing speed, wherein the target region is on at least one of two sides of the playing interface.

In some embodiments, the apparatus further includes: a highlighting unit, configured to highlight the target region in the process of playing the video.

In some embodiments, the fast multiplied-speed playing operation includes at least one of: a long-press operation; a shaking operation; and a voice input operation.

In some embodiments, the apparatus further includes: a third playing unit, configured to play, in response to a multiplied-speed playing exiting operation performed on the playing interface, the video according to a default multiplied playing speed.

In some embodiments, in a case that the fast multiplied-speed playing operation is a long-press operation, in a process of responding to the multiplied-speed adjustment operation, a sustained response is made to the long-press operation, and the multiplied-speed playing exiting operation is a release operation corresponding to the long-press operation.

In some embodiments, the apparatus further includes: a fourth displaying unit, configured to display, in response to a triggering operation performed on a playing progress bar of the video in the process of playing the video, fourth prompt information, wherein the fourth prompt information indicates to perform the fast multiplied-speed playing operation on the playing interface to play the video according to the first multiplied playing speed.

In some embodiments, the apparatus further includes: a fifth displaying unit, configured to display fifth prompt information when the video is being played according to the first multiplied playing speed, wherein the fifth prompt information indicates an operation manner for adjusting the playing progress of the video.

In some embodiments, the apparatus further includes: a fourth playing unit, configured to play, in response to the progress adjustment operation performed on the playing interface when the video is being played according to the first multiplied playing speed, the video according to both a playing progress corresponding to the progress adjustment operation and the first multiplied playing speed.

In some embodiments, the progress adjustment operation includes at least one of: sliding towards a third direction; and sliding towards a fourth direction. The third direction is opposite to the fourth direction, and the third direction and the fourth direction respectively correspond to different adjustment directions of the playing progress.

In some embodiments, the progress adjustment operation includes at least one of: a dragging operation performed on the playing progress bar of the video; and a triggering operation performed on any position on the playing progress bar.

In some embodiments, the apparatus further includes: a fifth playing unit, configured to: play, in response to a multiplied-speed adjustment operation performed on the playing interface in the process of playing the video according to both the playing progress corresponding to progress adjustment operation and the first multiplied playing speed, the video according to a third multiplied playing speed corresponding to the multiplied-speed adjustment operation. The third multiplied playing speed is different with the first multiplied playing speed.

In some embodiments, the apparatus further includes: a sixth display unit, configured to display, in response to the progress adjustment operation, sixth prompt information on the playing interface. The sixth prompt information indicates the playing progress corresponding to the progress adjustment operation.

It should be noted that: In case of playing a video, the apparatus for playing the video provided in the foregoing embodiments is only illustrated by division of all the above functional modules. In practical application, the foregoing functions may be allocated to and completed by different functional modules as required, that is, an inner structure of a device is divided into different functional modules, so as to complete all or some of the functions described above. In addition, the apparatus for playing the video and the method for playing the video according to the above embodiments belong to the same concept, and specific implementation processes thereof are described in the method embodiments in detail, and are not repeated here.

In some exemplary embodiments, an electronic device is further provided. The electronic device includes a processor and a memory. The memory is configured to store at least one computer program, and the at least one computer program is loaded and executed by the processor to perform the method for playing the video in the embodiments of the present disclosure.

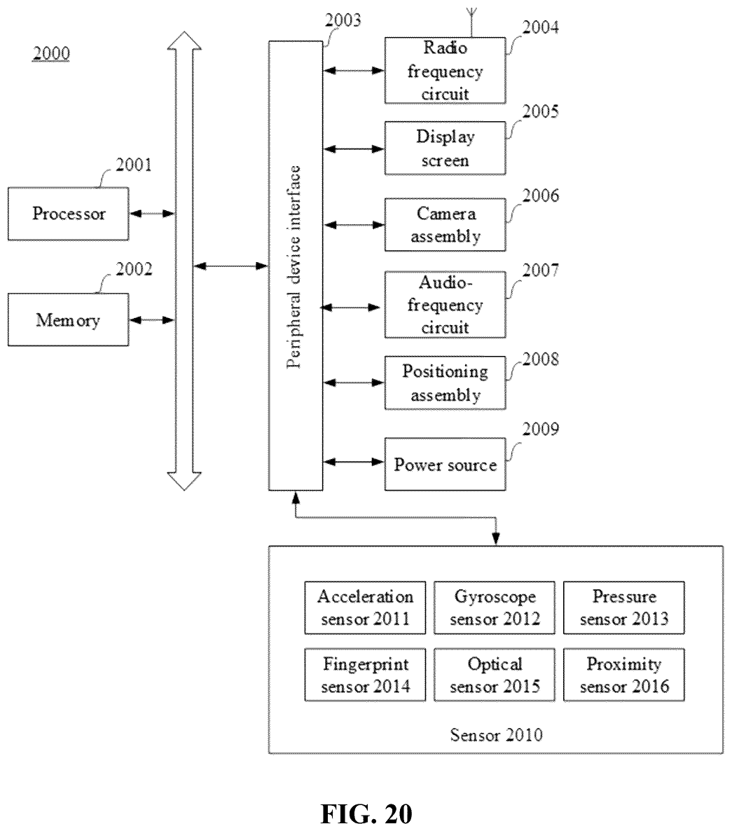

The electronic device is a terminal, which is taken as an example. FIG. 20 is a structural block diagram of a terminal according to some embodiments of the present disclosure. The terminal 2000 is: a smart phone, a tablet computer, a moving picture experts group audio layer III (MP3) player, a moving picture experts group audio layer IV (MP4) player, a notebook computer or a desktop computer. The terminal 2000 is also referred to as user equipment, a portable terminal, a laptop terminal, a desktop terminal, or the like.

Generally, the terminal 2000 includes: a processor 2001 and a memory 2002.

The processor 2001 includes one or more processing cores, such as a 4-core processor and an 8-core processor. The processor 2001 is implemented in at least one hardware form of a digital signal processor (DSP), a field-programmable gate array (FPGA), and a programmable logic array (PLA). The processor 2001 also includes a main processor and a coprocessor. The main processor is a processor defined to process data in an awake state, and is also referred to as a central processing unit (CPU). The coprocessor is a low-power processor defined to process data in a standby state. In some embodiments, the processor 2001 is integrated with a graphics processing unit (GPU) that is responsible for rendering and drawing contents that need to be displayed on a display screen. In some embodiments, the processor 2001 further includes an artificial intelligence (AI) processor for processing computing operations related to machine learning.

The memory 2002 includes one or more computer-readable storage media, which is non-transitory. The memory 2002 further includes a high speed random access memory, and a non-transitory memory, such as one or more magnetic disk storage devices and flash storage devices. In some embodiments, a non-transitory computer-readable storage medium in the memory 2002 is defined to store at least one program code. The at least one program code is defined to be executed by the processor 2001 to implement the processes executed by the terminal in the method for playing the video according to the embodiments of the present disclosure.

In some embodiments, the terminal 2000 further optionally includes: a peripheral device interface 2003 and at least one peripheral device. The processor 2001, the memory 2002, and the peripheral device interface 2003 are connected via buses or signal lines. The peripheral devices are connected to the peripheral device interface 2003 via a bus, signal line, or circuit board. Schematically, the peripheral devices include: at least one of a radio frequency circuit 2004, a display screen 2005, a camera assembly 2006, an audio-frequency circuit 2007, a positioning assembly 2008, and a power source 2009.

The peripheral device interface 2003 is operable to connect at least one peripheral device related to input/output (I/O) to the processor 2001 and the memory 2002. In some embodiments, the processor 2001, the memory 2002, and the peripheral device interface 2003 are integrated on the same chip or circuit board. In some other embodiments, any one or two of the processor 2001, the memory 2002, and the peripheral device interface 2003 are implemented on a separate chip or circuit board, which is not limited in the embodiments of the present disclosure.

The radio frequency circuit 2004 is operable to receive and transmit a radio frequency (RF) signal, which is also referred to as an electromagnetic signal. The radio frequency circuit 2004 communicates with a communication network and other communication devices via electromagnetic signals. The radio frequency circuit 2004 converts an electrical signal into an electromagnetic signal for transmission, or converts a received electromagnetic signal into an electrical signal. In some embodiments, the radio frequency circuit 2004 includes an antenna system, an RF transceiver, one or more amplifiers, a tuner, an oscillator, a digital signal processor, a codec chipset, a subscriber identity module card, and the like. The radio frequency circuit 2004 communicates with other terminals via at least one wireless communication protocol. The wireless communication protocol includes, but is not limited to, a metropolitan area network, generations of mobile communication networks (2G, 3G, 4G, and 5G), a wireless local area network, and/or a wireless fidelity (WiFi) network. In some embodiments, the radio frequency circuit 2004 further includes a near field communication (NFC) related circuit, which is not limited in the present disclosure.

The display screen 2005 is operable to display a user interface (UI). The UI includes graphics, text, icons, videos, and any combination thereof. In the case that the display screen 2005 is a touch display screen, the display screen 2005 also has the capacity to acquire a touch signal on or above a surface of the display screen 2005. The touch signal is input to the processor 2001 as a control signal for processing. In this case, the display screen 2005 is also operable to provide virtual buttons and/or virtual keyboards, which are also referred to as soft buttons and/or soft keyboards. In some embodiments, there is one display screen 2005 arranged on a front panel of the terminal 2000. In some other embodiments, there are at least two display screens 2005 arranged on different surfaces of the terminal 2000, respectively, or in a folded design. In some still other embodiments, the display screen 2005 is a flexible display screen arranged on a curved surface or a folded surface of the terminal 2000. The display screen 2005 is even set to a non-rectangular irregular pattern, that is, a special-shaped screen. The display screen 2005 is prepared by using a material such as a liquid crystal display (LCD) or an organic light-emitting diode (OLED).

The camera assembly 2006 is operable to capture images or videos. In some embodiments, the camera assembly 2006 includes a front camera and a rear camera. Generally, the front camera is on the front panel of the terminal, and the rear camera is on a back side of the terminal. In some embodiments, there are at least two rear cameras, which are any one of a primary camera, a depth of field camera, a wide-angle camera, and a telephoto camera, such that the primary camera and the depth of field camera are combined to implement a bokeh function, the primary camera and the wide-angle camera are combined to implement panoramic shooting and virtual reality (VR) shooting functions, or other combined shooting functions are implemented. In some embodiments, the camera assembly 2006 further includes a flash. The flash is a single-color temperature flash or a two-color temperature flash. The two-color temperature flash is a combination of a warm-light flash and a cold-light flash, and is employed for light compensation at different color temperatures.

The audio-frequency circuit 2007 includes a microphone and a speaker. The microphone is operable to acquire sound waves of the user and the environment, and convert the sound waves into electrical signals for input into the processor 2001 for processing, or into the radio frequency circuit 2004 for voice communication. For the purpose of stereo acquisition or noise reduction, there are a plurality of microphones disposed at different parts of the terminal 2000, respectively. The microphone is also an array microphone or an omnidirectional acquisition microphone. The speaker is operable to convert the electrical signal from the processor 2001 or the radio frequency circuit 2004 into sound waves. The speaker is a conventional film speaker and is also a piezoelectric ceramic speaker. In the case that the speaker is a piezoelectric ceramic speaker, not only can the electrical signal be converted into sound waves that are audible to humans, but also the electrical signal can be converted into sound waves that are inaudible to humans for ranging and the like. In some embodiments, the audio-frequency circuit 2007 is also include a headphone jack.

The positioning assembly 2008 is operable to position a current geographic location of the terminal 2000 for navigation or location-based service (LBS).

The power source 2009 is operable to supply power to the components in the terminal 2000. The power source 2009 is an alternating current, a direct current, a disposable battery, or a rechargeable battery. In the case that the power source 2009 includes a rechargeable battery, the rechargeable battery supports wired charging or wireless charging. The rechargeable battery is also operable to support fast charging.

In some embodiments, the terminal 2000 further includes one or more sensors 2010. The one or more sensors 2010 include, but are not limited to, an acceleration sensor 2011, a gyroscope sensor 2012, a pressure sensor 2013, a fingerprint sensor 2014, an optical sensor 2015, and a proximity sensor 2016.

The acceleration sensor 2011 is operable to detect accelerations on three coordinate axes of a coordinate system established by the terminal 2000. For example, the acceleration sensor 2011 is operable to detect components of the gravitational acceleration on the three coordinate axes. The processor 2001 controls the display screen 2005 to display the user interface in a landscape view or a portrait view based on a gravity acceleration signal acquired by the acceleration sensor 2011. The acceleration sensor 2011 is also operable to acquire game data or motion data of the user.

The gyroscope sensor 2012 detects a body direction and a rotation angle of the terminal 2000, and the gyroscope sensor 2012, together with the acceleration sensor 2011, acquires a 3D motion of the user to the terminal 2000. Based on the data acquired by the gyroscope sensor 2012, the processor 2001 implements the following functions: motion sensing (for example, changing the UI according to a tilting operation of the user), image stabilization during shooting, game control, and inertial navigation.

The pressure sensor 2013 is disposed at a side frame of the terminal 2000 and/or underneath the display screen 2005. In the case that the pressure sensor 2013 is disposed at the side frame of the terminal 2000, a holding signal of the user to the terminal 2000 is detected, and the processor 2001 performs left-right hand recognition or shortcut operation based on the holding signal acquired by the pressure sensor 2013. In the case that the pressure sensor 2013 is disposed underneath the display screen 2005, an operability control on the UI is controlled through the processor 2001 based on the pressure operation of the user on the display screen 2005. The operability control includes at least one of a button control, a scroll bar control, an icon control, and a menu control.

The fingerprint sensor 2014 is operable to acquire a fingerprint of the user, and the processor 2001 identifies the identity of the user based on the fingerprint acquired by the fingerprint sensor 2014, or the fingerprint sensor 2014 identifies the identity of the user based on the acquired fingerprint. Upon identifying that the identity of the user is a trusted identity, the processor 2001 authorizes the user to perform related sensitive operations, including unlocking the screen, viewing encrypted information, downloading software, paying, changing settings, and the like. The fingerprint sensor 2014 is on the front side, back side or side surface of the terminal 2000. In the case that a physical key or a manufacturer logo is provided on the terminal 2000, the fingerprint sensor 2014 is integrated with the physical key or the manufacturer logo.

The optical sensor 2015 is operable to acquire ambient light intensity. In some embodiments, the processor 2001 controls the display brightness of the display screen 2005 based on the ambient light intensity acquired by the optical sensor 2015. Schematically, in the case of high ambient light intensity, the display brightness of the display screen 2005 is increased; and in the case of low ambient light intensity, the display brightness of the display screen 2005 is lowered. In another embodiment, the processor 2001 also dynamically adjusts the shooting parameters of the camera assembly 2006 based on the ambient light intensity acquired by the optical sensor 2015.

The proximity sensor 2016, also known as a distance sensor, is typically disposed on the front panel of the terminal 2000. The proximity sensor 2016 is operable to acquire the distance between the user and the front side of the terminal 2000. In some embodiments, in the case that the proximity sensor 2016 detects that the distance between the user and the front side of the terminal 2000 is gradually decreasing, the processor 2001 controls the display screen 2005 to switch from a bright screen state into a blackout screen state; and in the case that the proximity sensor 2016 detects that the distance between the user and the front side of the terminal 2000 is gradually increasing, the processor 2001 controls the display screen 2005 to switch from the blackout screen state into the bright screen state.

Those skilled in the art will appreciate that the structure illustrated in FIG. 20 does not constitute limitation of the terminal 2000, and that more or fewer components than those illustrated are included, or some of the components are combined, or a different arrangement of components is employed.

In some exemplary embodiments, a non-transitory computer-readable storage medium including program codes, such as a memory including program codes. The above program codes are executable by a processor of a terminal to perform the above method for playing the video. In some embodiments, the computer-readable storage medium is a read-only memory (ROM), a Random Access Memory (RAM), a compact-ROM (CD-ROM), a magnetic tape, a floppy disk, an optical data storage device, or the like.

In some exemplary embodiments, a computer program product is further provided. The computer program product includes a computer program. The computer program, when executed by a processor, performs the method for playing the video.

All embodiments of the present disclosure may be implemented alone or in combination with other embodiments and are considered to be within the protection scope of the present disclosure as claimed.

What is claimed is:

1. A method for playing a video, performed by an electronic device, and comprising:
playing, in response to a fast multiplied-speed playing operation performed on a playing interface of the video when the video is being played, the video according to a first multiplied playing speed which is associated with the fast multiplied-speed playing operation; and
playing, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.

2. The method according to claim 1, wherein the multiplied-speed adjustment operation comprises at least one of: sliding towards a first direction, and sliding towards a second direction;
wherein the first direction is opposite to the second direction, and the first direction and the second direction respectively correspond to different multiplied playing speeds.

3. The method according to claim 1, wherein the multiplied-speed adjustment operation is an operation performed on a multiplied-speed adjustment track displayed on the playing interface, and the multiplied-speed adjustment track indicates a plurality of multiplied playing speeds.

4. The method according to claim 3, wherein the multiplied-speed adjustment track comprises a plurality of multiplied-speed levels, different multiplied-speed levels respectively correspond to different multiplied playing speeds, and the multiplied-speed adjustment operation comprises at least one of:
a triggering operation performed on the multiplied-speed levels; and
sliding on the multiplied-speed adjustment track to reach one of the multiplied-speed levels.

5. The method according to claim 3, wherein two ends of the multiplied-speed adjustment track respectively indicate an upper limit and a lower limit of adjustment of a multiplied playing speed; and the multiplied-speed adjustment operation comprises at least one of:
a triggering operation performed on any position on the multiplied-speed adjustment track; and
sliding on the multiplied-speed adjustment track to reach any position.

6. The method according to claim 1, wherein the method further comprises: sending, in response to the multiplied-speed adjustment operation, a vibration prompt according to a vibration level corresponding to the second multiplied playing speed.

7. The method according to claim 1, wherein the method further comprises at least one of:
displaying first prompt information when the video is being played according to the first multiplied playing speed, wherein the first prompt information indicates a current multiplied playing speed of the video;
displaying second prompt information when the video is being played according to the first multiplied playing speed, wherein the second prompt information indicates an operation manner of the multiplied-speed adjustment operation; and
displaying third prompt information in response to the multiplied-speed adjustment operation, wherein the third prompt information indicates an operation process corresponding to the multiplied-speed adjustment operation.

8. The method according to claim 1, wherein playing, in response to the fast multiplied-speed playing operation performed on the playing interface of the video when the video is being played, the video according to the first multiplied playing speed which is associated with the fast multiplied-speed playing operation comprises:
playing, in response to the fast multiplied-speed playing operation performed on a target region of the playing interface when the video is played, the video according to the first multiplied playing speed, wherein the target region is on one of two sides of the playing interface.

9. The method according to claim 8, wherein the method further comprises: highlighting the target region when the video is being played.

10. The method according to claim 1, wherein the fast multiplied-speed playing operation comprises at least one of: a long-press operation; a shaking operation; and a voice input operation.

11. The method according to claim 1, wherein the method further comprises: playing, in response to a multiplied-speed playing exiting operation performed on the playing interface, the video according to a default multiplied playing speed.

12. The method according to claim 11, wherein in a case that the fast multiplied-speed playing operation is a long-press operation, in a process of responding to the multiplied-speed adjustment operation, a sustained response is made to the long-press operation; and the multiplied-speed playing exiting operation is a release operation corresponding to the long-press operation.

13. The method according to claim 1, wherein the method further comprises at least one of:
displaying, in response to a triggering operation performed on a playing progress bar of the video when the video is being played, fourth prompt information, wherein the fourth prompt information indicates to perform the fast multiplied-speed playing operation on the playing interface to play the video according to the first multiplied playing speed; and
displaying fifth prompt information when the video is being played according to the first multiplied playing speed, wherein the fifth prompt information indicates an operation manner for adjusting a playing progress of the video.

14. The method according to claim 1, wherein the method further comprises:
playing, in response to a progress adjustment operation performed on the playing interface when the video is being played according to the first multiplied playing speed, the video according to both a playing progress corresponding to the progress adjustment operation and the first multiplied playing speed.

15. The method according to claim 14, wherein the progress adjustment operation comprises at least one of: sliding towards a third direction; and sliding towards a fourth direction on a target region of the playing interface,
wherein the third direction is opposite to the fourth direction, and the third direction and the fourth direction respectively correspond to different adjustment directions of the playing progress.

16. The method according to claim 14, wherein the progress adjustment operation comprises at least one of: a dragging operation performed on a playing progress bar of the video; and a triggering operation performed on any position on the playing progress bar.

17. The method according to claim 14, wherein the method further comprises:
playing, in response to the multiplied-speed adjustment operation performed on the playing interface when the video is being played according to both the playing progress corresponding to the progress adjustment operation and the first multiplied playing speed, the video according to a third multiplied playing speed corresponding to the multiplied-speed adjustment operation, wherein the third multiplied playing speed is different with the first multiplied playing speed.

18. The method according to claim 1, wherein the method further comprises:
playing, in response to a progress adjustment operation performed on a target region of the playing interface when the video is being played according to the first multiplied playing speed, the video according to both a playing progress corresponding to the progress adjustment operation and the first multiplied playing speed;
wherein the fast multiplied-speed playing operation is a long-press operation on the target region of the playing interface;
wherein the multiplied-speed adjustment operation comprises a sliding operation towards a first direction, and a sliding operation towards a second direction on the target region, and wherein the first direction is opposite to the second direction, and the first direction and the second direction respectively correspond to different multiplied playing speeds;
wherein the progress adjustment operation comprises a sliding towards a third direction; and sliding operation towards a fourth direction on the target region of the playing interface, and wherein the third direction corresponds to a video forward play direction, and the fourth direction corresponds to a video backward play direction, wherein the third direction is opposite to the fourth direction, and wherein the third direction and the fourth direction are different from the first direction and the second direction.

19. An electronic device, wherein the electronic device comprises:
one or more processors; and
a memory, configured to store program codes executable on the processor,
wherein the processor is configured to execute the program codes to perform the following steps:
playing, in response to a fast multiplied-speed playing operation performed on a playing interface of a video when the video is being played, the video according to a first multiplied playing speed which is associated with the fast multiplied-speed playing operation; and
playing, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.

20. A non-transitory computer-readable storage medium having program codes therein, wherein the program codes, when executed by a processor of an electronic device, cause the electronic device to perform the following steps:
playing, in response to a fast multiplied-speed playing operation performed on a playing interface of a video when the video is being played, the video according to a first multiplied playing speed which is associated with the fast multiplied-speed playing operation; and
playing, in response to a multiplied-speed adjustment operation performed on the playing interface when the video is being played according to the first multiplied playing speed, the video according to a second multiplied playing speed which corresponds to the multiplied-speed adjustment operation, wherein the second multiplied playing speed is different with the first multiplied playing speed.
